(19) United States
(12) Patent Application Publication
(10) Pub. No.: US 2002/0142781 A1
(43) Pub. Date: Oct. 3, 2002

(54) Resolution of ambiguity of position location for user terminals operating in a low earth orbit satellite system

(75) Inventors: Robert A. Wiedeman, Sedalia, CO (US); Michael J. Sites, Fremont, CA (US)

Correspondence Address: Harry F. Smith, Esq., Ohlandt, Greeley, Ruggiero & Perle, L.L.P., One Landmark Square, 10th Floor, Stamford, CT, 06901-2682, US

(73) Assignee: Globalstar L.P.

(21) Appl. No.: 09/750,998

(22) Filed: Dec. 29, 2000

(51) Int. Cl. H04Q 7/20

(52) U.S. Cl. 455/456; 455/429

(57) ABSTRACT

A method for determining whether a gateway will service a user terminal in a satellite communication system comprises the steps of (1) determining whether a position of the user terminal is ambiguous, and (2) if the position is ambiguous, then (a) determining whether a previous registration of a service provider for the user terminal matches a current service provider accessible via the gateway, and (b) if the previous registration matches the current service provider, then accepting the user terminal for service by the gateway. Alternate methods involve determining that the user terminal is at either of two ambiguous positions, and (1) determining whether both of the two ambiguous positions are within a service area of the gateway, (2) determining whether at least one of the two ambiguous positions is within a restricted area for which the gateway does not provide service, or (3) determining a parameter of a beam transmitted from the user terminal to a satellite of the satellite communication system.

### FIELD OF THE INVENTION

This invention relates generally to satellite communication systems and, more particularly, to a technique for resolving an ambiguous position location of a user terminal in a satellite communication system.

### BACKGROUND OF THE INVENTION

In a satellite communication system, a user terminal (UT), such as a mobile telephone, connects to a terrestrial gateway via a satellite. Through the gateway, the UT is enabled to communicate with another device. A desirable feature of a satellite communication system is that it emulates the terrestrial systems of cellular telephony for both the US standard IS-41 and the European system, called Global Mobile System for Cellular Communications (GSM). In order to emulate these systems and inter-operate with them, it is convenient to use a Visitor Location Register (VLR) or database and a Home Location Register (HLR) or database to effect UT mobility management.

When connecting a UT to the satellite communication system, it is important that the UT be registered into the system by which it is going to be served. The UT may be one belonging to a “Home” Mobile Switching Center (MSC) or it may be a visitor using the VLR. These systems utilize the location of the UT in some manner because the systems must know where the UT is within the system or systems.

Terrestrial systems utilize “Location Areas”, which are either a single cell or a group of cells. The actual physical location of a UT in terms of latitude and longitude is not required, just the cell or group of cells in which the user is located.

In a satellite system this is not practical because the location areas are large and created by the motion of satellites over a fixed geographical area. The geographical area generally contains a country boundary or a group of country boundaries. In some cases the geographical area includes oceans or portions of oceans, and in other cases the country or countries may be divided into sub regions. In any case the satellite system has large geographical areas, and it is important to know where the UT is within these “Location Areas” within some relatively small error bound. The current regulation for defining the error bound for boundaries of service areas has been established as knowledge of the position of the UT to within 10 km.

Common techniques for locating a UT in a satellite system include using a Global Positioning Satellite (GPS) receiver or some other external position location means (such as LORAN) to calculate the UT's position. Thereafter, the position is reported to a serving gateway.

Another technique for locating the UT is to use the satellite communication system itself to determine the location. Such a system typically includes a multiple satellite constellation, with a plurality of satellites orbiting overhead. In one implementation, the satellites are in a 1414 km circular orbit, inclined at 52 degrees, and arranged in 8 planes spaced 45 degrees apart. However, the number of satellites instantaneously available to the UT is considerably smaller than that of GPS. In addition, the satellites and gateways, do not have a Geometric Dilution of Precision (GDOP) optimized for making precision position location calculations. Typically only 2 or 3 satellites are available. In some instances, especially above 60 degrees North or South, and between the equator and 20 degrees North or South, there is only one satellite connected to a gateway that is available to contribute to the position location function.

Multiple satellite systems first calculate a number of parameters describing the geometric relationship between the satellites and the UT. Then triangulation calculations are performed using a range parameter describing the distance between a measuring satellite and the UT. Each range parameter represents a sphere centered on the measuring satellite. The possible solutions are described by the intersection of these spheres and the surface of the earth. If three satellites (ranges) are available there is no ambiguity and the location of the UT is determinable within some error based on the accuracy of the measured ranges. However, if less than three satellites (ranges) are available then there is the possibility of an ambiguity of location, with two solutions presenting themselves, one correct and the other incorrect.

U.S. Pat. No. 5,920,284 to Victor describes a technique of resolving these ambiguities. This technique uses the satellite beams to resolve these ambiguities. However, the satellite beams of many of the low earth orbit systems are too large to effect timely position location and resolving of the ambiguity. Also, in a case where the UT and the ambiguity position are entirely within one beam, the method of U.S. Pat. No. 5,920,284 may not provide a correct solution.

A single satellite that is contemporaneously accessible to both a gateway and a UT is said to be co-visible to the gateway and the UT. The advent of a technique known as Beam Over Reach (BOR) attempts to extend coverage from gateways to increase the opportunity for a single co-visible satellite to provide a position location for UTs within beam over reach areas. BOR increases the service area by expanding the zone of connectivity beyond that which is ordinarily served at a certain acceptable level of quality of service.

With only one satellite (co-)visible to the UT and the gateway at registration time or at the time of traffic channel request, there is the possibility of an ambiguity of location. It is important to resolve this ambiguity prior to authorizing service.

### OBJECTS OF THE INVENTION

It is a first object of this invention to provide an improved method for resolving an ambiguous position of a user terminal in a satellite communication system.

It is a second object of this invention to provide an improved method for determining whether a gateway will service a user terminal that is alleged to be at either of two ambiguous positions.

### SUMMARY OF THE INVENTION

In accordance with a first method of the present invention, a method is provided for determining whether a gateway will service a user terminal in a satellite communication system. The method comprises the steps of (1) determining whether a position of the user terminal is ambiguous, and (2) if the position is ambiguous, then (a) determining whether a previous registration of a service provider for the user terminal matches a current service provider accessible via the gateway, and (b) if the previous registration matches the current service provider, then accepting the user terminal for service by the gateway.

In accordance with a second method of the present invention, a method is provided for determining whether a gateway will service a user terminal in a satellite communication system. The method comprises the steps of (1) determining that the user terminal is at either of two ambiguous positions, (2) determining whether both of the two ambiguous positions are within a service area of the gateway, and (3) if both of the two ambiguous positions are within the service area, then accepting the user terminal for service by the gateway.

In accordance with a third method of the present invention, a method is provided for determining whether a gateway will service a user terminal in a satellite communication system. The method comprises the steps of (1) determining that the user terminal is at either of two ambiguous positions, (2) determining whether at least one of the two ambiguous positions is within a restricted area for which the gateway does not provide service, and (3) if at least one of the two ambiguous positions is within the restricted area, then rejecting the user terminal for service by the gateway.

In accordance with a fourth method of the present invention, a method is provided for resolving a position of a user terminal in a satellite communication system. The method comprises the steps of (1) determining that the user terminal is at either of two ambiguous positions, (2) determining a parameter of a beam transmitted from the user terminal to a satellite of the satellite communication system, and (3) determining that the user terminal is at a first of the two ambiguous positions based on the parameter.

In accordance with a fifth method of the present invention, a method is provided for determining whether a first gateway will service a user terminal in a satellite communication system. The method comprises the steps of (1) determining, based on data from a first satellite of the communication system that has a radio frequency (RF) link to the first gateway, that a position of the user terminal is ambiguous, (2) determining, at a second gateway, based on data from a second satellite of the satellite communication system that does not have an RF link to the first gateway, an unambiguous position of the user terminal, (3) obtaining the unambiguous position from the second gateway, and (4) if the unambiguous position indicates that the user terminal is located in a service area of the first gateway, then accepting the user terminal for service by the first gateway.

In accordance with a sixth method of the present invention, a method is provided for determining whether a gateway will service a user terminal in a satellite communication system. The method comprises the steps of (1) determining, based on data from a first satellite of the communication system that has a radio frequency (RF) link to the gateway, that a position of the user terminal is ambiguous, (2) obtaining, from a second satellite of the communication system that does not have an RF link to the gateway, data relating to the position of the user terminal, (3) determining, from the data from the second satellite, an unambiguous position of the user terminal, and (4) if the unambiguous position indicates that the user terminal is located in a service area of the gateway, then accepting the user terminal for service by the gateway.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 is an illustration of a satellite communication system, in accordance with the present invention;

FIG. 2 is an illustration of a satellite communication system showing an ambiguity resulting from a set of position location measurements taken at two different times by a user terminal of a satellite;

FIG. 3 is an illustration of a satellite communication system showing an ambiguity resulting from a set of position location measurements of Doppler and delta time from one satellite at a single time period;

FIGS. 4, 5 and 6 are maps showing how regions of ambiguity can occur in a portion of a service area during a pass of a satellite;

FIGS. 7, 8 and 9 are maps depicting the situation of FIGS. 4, 5 and 6, using return link beam configurations;

FIG. 10 is a map that shows how the ambiguity problem is aggravated by the use of yaw steering;

FIG. 11 is a map that shows a gateway serving a “beam over-reach” area with two zones of ambiguity;

FIG. 12 is a map that shows a gateway serving a “beam over-reach” area in the Atlantic Ocean;

FIG. 13 is a map showing a region of ambiguity that includes a “non-friendly” territory;

FIG. 14 is a map showing a region of ambiguity that includes a first territory served by a first service provider and a first gateway, and a second territory served by a second service provider and a second gateway;

FIG. 14A is a map that shows a satellite over the West Coast of India;

FIG. 15 is an illustration of a satellite transmit beam pattern and a receive beam pattern overlaying one another;

FIG. 16 is a map that shows a relationship between transmit beam patterns and receive beam patterns;

FIG. 17A is an illustration of a transmit beam pattern and a receive beam pattern moving along a ground track;

FIG. 17B is an antenna pattern of a beam received at section M-M of FIG. 17A;

FIG. 18A is an antenna pattern of receive beams for the case where a gateway is receiving the UT only on one beam;

FIG. 18B is an antenna pattern of receive beams for the case where a gateway is receiving the UT at the same signal strength on two beams;

FIGS. 19A-19C are maps showing a pass of a satellite over a length of the Ukraine;

FIGS. 20A and 20B are maps showing a pass of a satellite across the Ukraine;

FIG. 21A is a map showing a service area surrounded by a restricted zone;

FIG. 21B is a map showing a satellite passing over a juncture of a restricted zone and a non-restricted zone;

FIG. 21C is a map showing a satellite passing over a service area surrounded by a non-restricted zone;

FIG. 22 is a flowchart of a preferred embodiment of a method for resolving an ambiguous position of a UT, in accordance with the present invention;

FIG. 23 is an illustration showing the basic elements of a satellite communication system;

FIG. 24 is an illustration of a satellite beam as the satellite passes over a gateway and a region that includes several user terminals;

FIG. 25A is an illustration showing two satellites providing coverage for a user terminal;

FIG. 25B is an illustration of a contour of a fixed region where during a period of time, a user station may communicate continuously with a gateway via two satellites; and

FIG. 26 is an illustration of a co-visibility contour plot for a multi-satellite constellation.

FIGS. 27A -27I are useful for understanding various aspects of co-visibility, gateway coverage areas and power flux densities (PFDs).

### DETAILED DESCRIPTION OF THE INVENTION

A region of co-visibility of Radio Resource availability to a gateway, the equivalent to the “cells” in a cellular system, is generated by the design of the satellite system antennas and beams, the motion of the satellites in their orbits and the arrangement of the gateways on the surface of the earth. The following discussion describes why this is true.

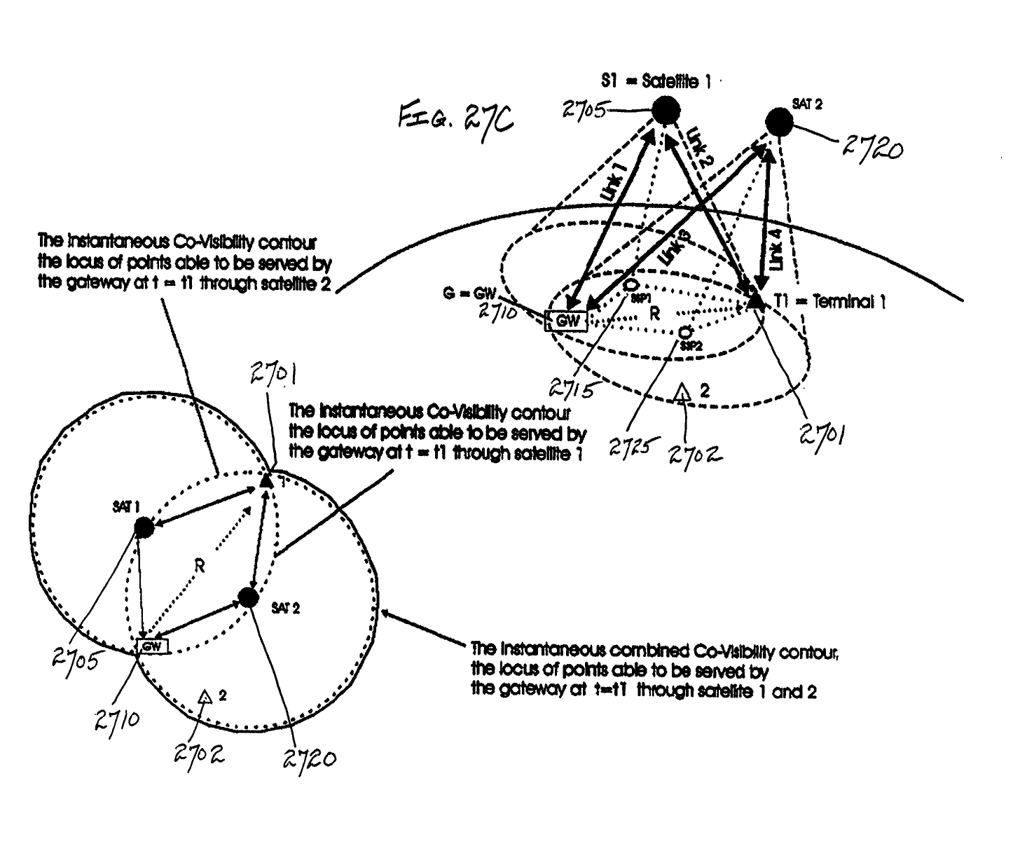

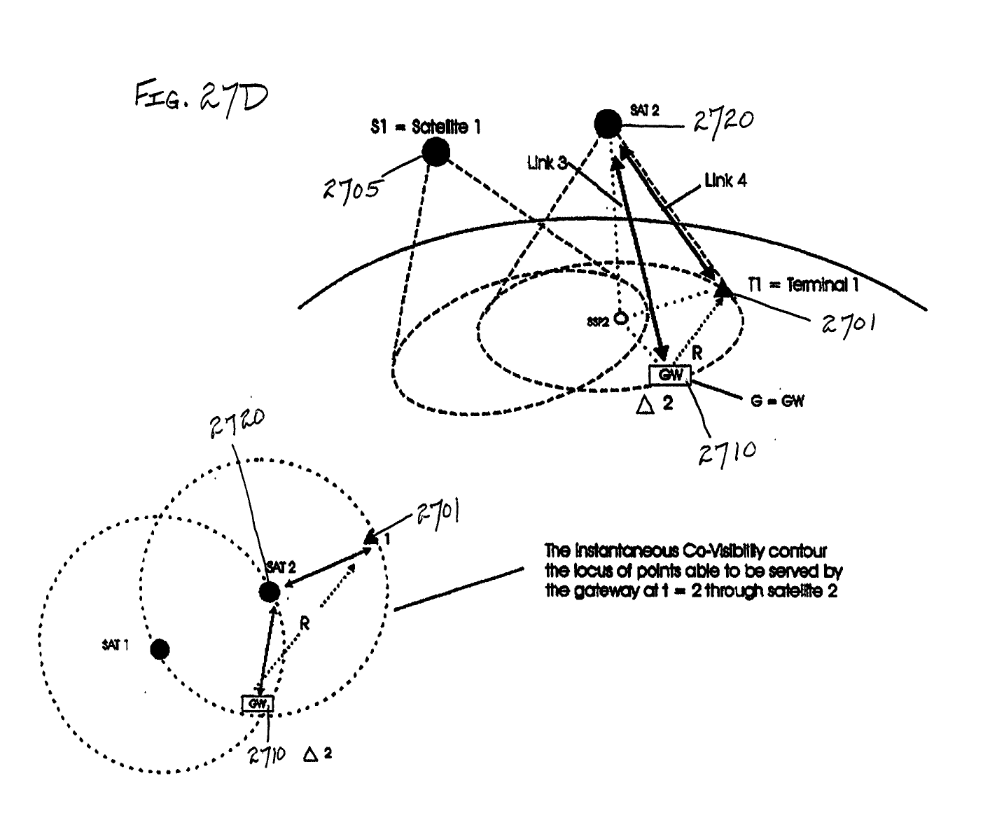

The basic elements of the configuration are shown in FIG. 23. A gateway 2305, also referred to as an Earth station, is placed at a random place on the surface of the earth. A satellite 2310 is shown orbiting near gateway 2305 and has a radio frequency (RF) beam, which may include one or more sub-beams, covering it with RF energy. Gateway 2305 is tracking satellite 2310 and is able to communicate with it. Satellite 2310 is preferably a repeating type, although other types of communications satellites are possible, and is able to communicate over the entirety of the area 2315. There are a plurality of UTs on or near the surface of the earth, some located within the area 2315 and some not.

In the example, UT-1 and UT-3 are able to communicate with gateway 2305 over the satellite relay, while UT-2 is not able to communicate with gateway 2305. When a UT is able to communicate with gateway 2305, co-visibility is available. The instantaneous distance from gateway 2305 to the extent of the instantaneous co-visibility contour is determined by the altitude of satellite 2310, and the individual minimum elevation angles required by the UT and gateway 2305, shown in FIG. 23 as alpha (a) and theta (θ) respectively, that will support communications links.

If satellite 2310 were stationary, the covisibility contour also called the locus of points, i.e., area 2315, able to be served by the gateway at t=to would be as shown in FIG. 23. For the case shown in FIG. 23, UT-2 would not be served by satellite 2310.

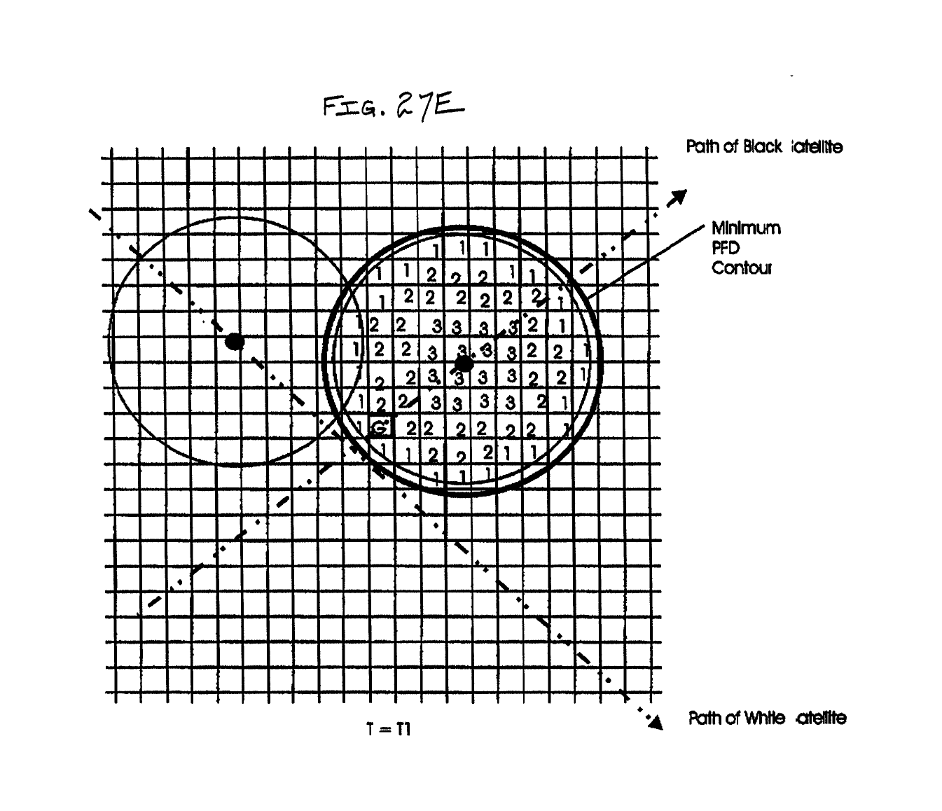

Low earth orbit satellites are in motion relative to a earth bound gateway. Consider FIG. 24, as an example, where satellite—gateway—UT geometry is shown for 6 time slots. The example in FIG. 24 is not drawn to scale, nor is it representative of any actual configuration. It is meant for illustration purposes only. Four UTs, namely UT-1, UT-2, UT-3 and UT-4 are located in a region around a gateway 2410.

At t=t₀, a satellite 2405 produces an RF beam 2415 that has not yet covered gateway 2410, and thus, no UTs are being served.

At t=t₁, gateway 2410 has been covered by RF beam 2415, and UT-3 and UT-4 can be served.

At t=t₂, gateway 2410 is able to serve UT-3 and UT-4, and also UT-1.

At t=t₃, satellite 2405 is no longer able to serve UT-3 but continues to serve UT-1 and UT-4.

At t=t₄, satellite 2405 is no longer able to serve UT-1 but continues to serve UT-4 and now can serve UT-2.

At t=t₅, satellite 2405 no longer serves any UTs because it cannot “see” gateway 2410.

In this example, t=t₁, through t=t₄ is the time of the satellite pass. UT-4 had continuous coverage by satellite 2405 during the entire pass. In fact any UT within the area of RF beam 2415 would have had continuous coverage. For the period t=t₁, through t=t₄, RF beam 2415 is a location area where radio resources are continuously available and represent the equivalence to a set of terrestrial cells continuously having available radio resource.

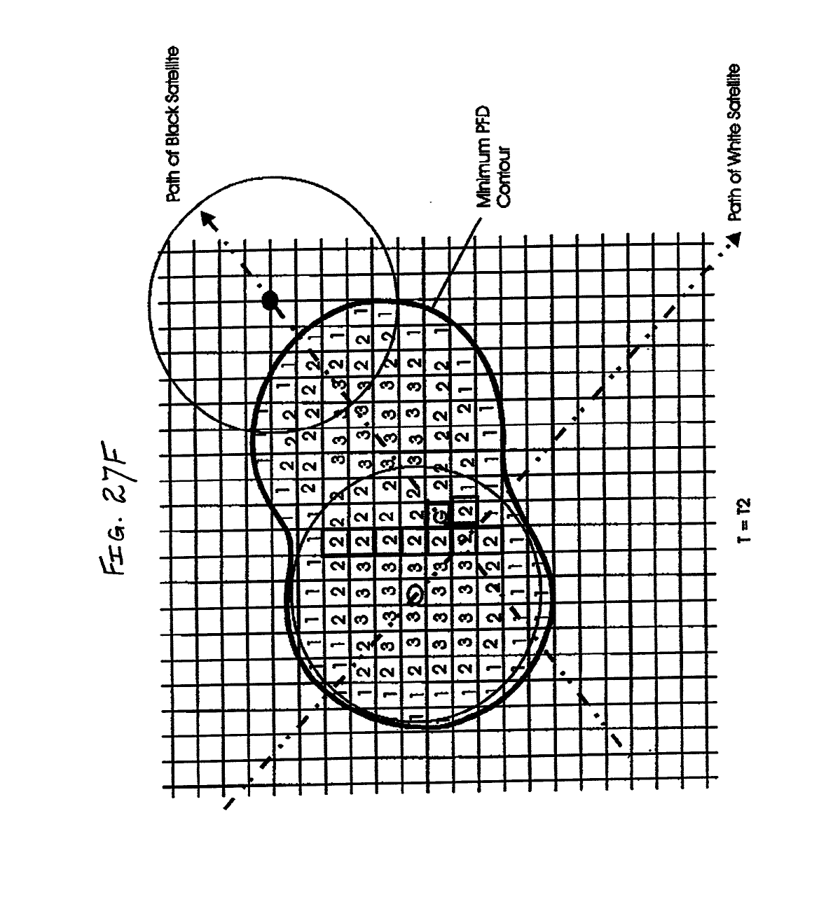

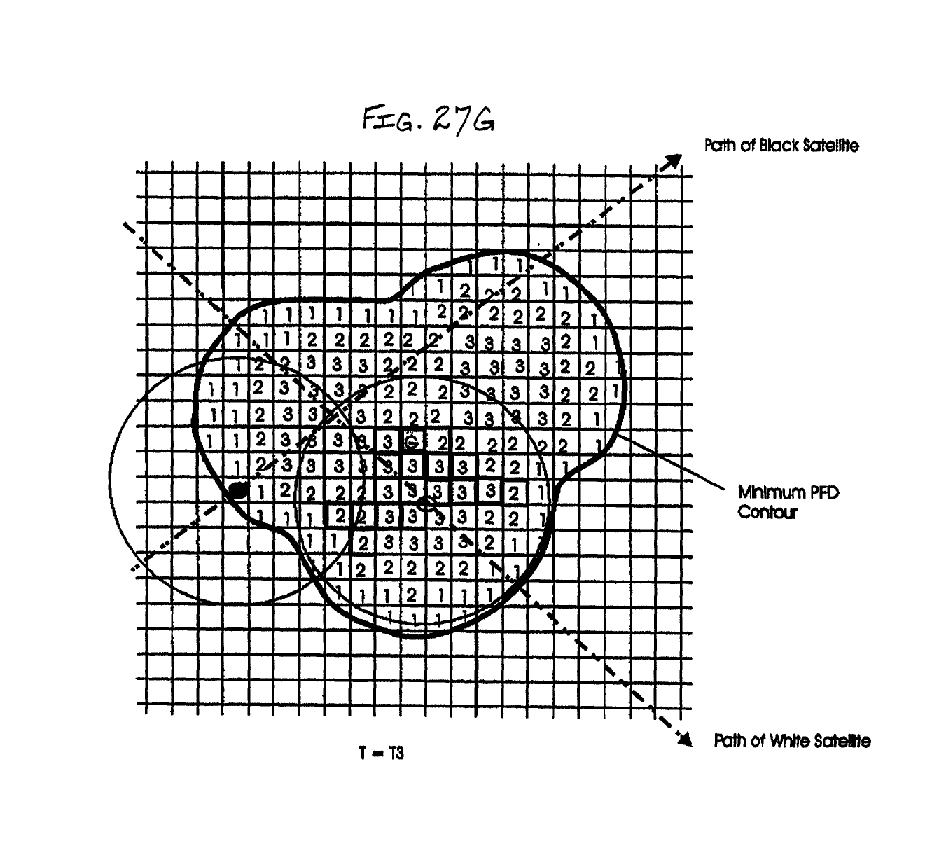

FIG. 25A extends the example of FIG. 24 to the case of multiple satellites. In FIG. 25A, a second satellite 2505 is added to the geometry over the same time period t=t₁ through t=t₄. Satellite 2505 is on a different path than satellite 2405 since its orbit is different.

As shown in the FIG. 25A, at t₁ gateway 2410 is able to communicate with satellite 2505 as well as with satellite 2405. Since UT-2 is within co-visibility of both itself and gateway 2410 through satellite 2505, communications can take place. As satellite 2505 moves along its orbit path it can continue to communicate with UT-2 until t=t₄.

As in the case of satellite 2405, a fixed area on the earth is created during the time period for satellite 2505 in which continuous communications is available. Since these two fixed areas are created during the same time period they together form the area on the ground where radio resources are continuously available and represent the equivalence of a terrestrial cells continuously available radio resource.

FIG. 25B shows the contour of a composite fixed region on earth where during the time period t=t1 through t=t4, UTs may communicate continuously with gateway 2410 100% of the time via satellites 2405 and 2505. If the system designer does not require 100% radio resource availability a contour which is larger than the 100% contour may be developed.

The example shown in FIGS. 23, 24, 25A and 25B, without scale and actual configuration, is provided to illustrate the principle of co-visibility. Generally, the continuous communication co-visibility region, which is equivalent to a continuous propagation cell of a terrestrial system, is determined by mathematical modeling of the satellite antenna beam configurations, the satellite constellation and the location of the gateways. The size and shape of the region depends on the constellation of satellites, and the latitude of the gateway. This region can be defined further by other factors than the line of sight math model. Factors such as blocking and shadowing of a UT by buildings, trees and other obstructions, as well as UT performance may be used to further modify the region of co-visibility and available radio resource.

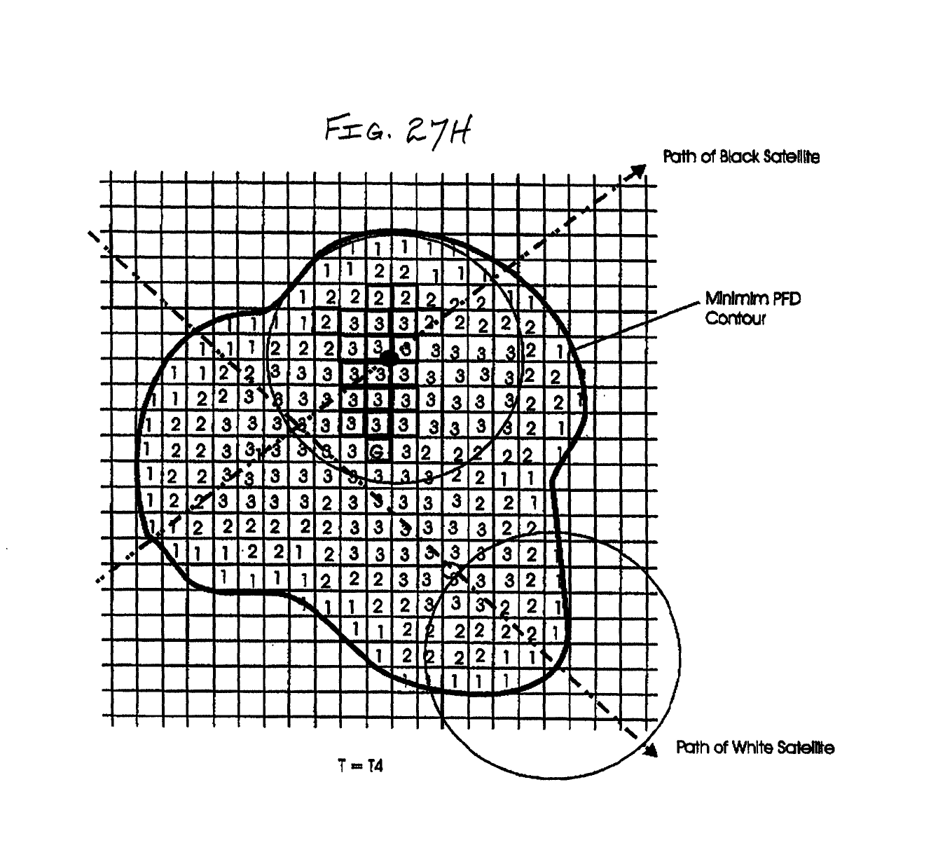

FIG. 26 shows a typical Co-Visibility Contour Plot for a Northern Latitude Gateway using a multi-satellite constellation. The heavy dark line is the fixed region 2605 on the earth where there is 100% propagation to UTs providing Radio Resources in the same manner as region 2650 for the terrestrial cell site shown in the upper left hand corner. The dashed line outside of the 100% contour is a region 2610 of less quality that the service provider may choose to use depending on the economics of service, similarly to that of region 2655 found in the terrestrial system.

Also shown in FIG. 26 is a region 2615 of 100% double coverage. This area does not exist for all gateways. In any case, the commercial service area of the gateway does not necessarily conform to the contours, but instead is determined by political boundaries such as country borders, or other economic boundaries. However, one or more boundaries of the service area may be constructed of the gateway coverage area generated by the means described above. This area, lying within the contours is generally an electronic map held in the gateway computing system memory constructed with points or nodes that are connected by straight or curved lines. UTs requiring access to the system must be within this map area.

The satellite system operates by UTs requesting service registration. The UT requests service by transmitting a service request, in a manner similar to that of a cellular system. The UT is position located by a gateway. If the UT is within the service area, and is co-visible to the gateway, the UT is granted service. If the UT is outside of the electronic map boundary the UT is denied access.

The electronic map generally, does not have much or any 100% double coverage area. It generally has a large amount of 100% single satellite coverage, and may have significant areas with less than 100% single satellite coverage.

A determination of the location of a UT involves a use of measurements of range and range rate from the UT to various satellites. If there is only one satellite visible at the time of registration or at the time of traffic channel request, then there is the possibility of an ambiguity of location, with two solutions presenting themselves, one solution being correct and the other being incorrect.

After measuring the range to a satellite, the UT transmits the measurement back to the gateway on the return link as part of one or more various messages required and defined in the MSS Air Interface (AI) specification and protocol. In turn, the gateway uses the range information and the time they were made to calculate the location of the UT.

In an example system utilizing CDMA modulation with a synchronization pilot, the UT performs measurements of the range to the satellites that it is tracking synchronization channels, e.g. pilot channels, in the active set with special treatment of the satellite that is sending the UT its paging channel. The reference satellite is the satellite with the UT's paging channel. The UT stores the following information:

(1) The identifier of the reference satellite.

REF_SAT_ID=SAT_ID of satellite sending paging channel.

(2) The identifier of the measured satellite.

POS_SAT_PN of the satellite that is being measured.

(3) The signed time difference between that of the measured satellite and the reference satellite, i.e., the start time of the outer PN cycle of the reference satellite and the next start of the outer PN cycle of the measured satellite within ⅛^{th} of a chip.

(4) The carrier frequency offset between that of the nominal carrier of the reference satellite, as determined by the UT local oscillator, and that of the measured satellite

(5) The system time, i.e., POS_AGE, of the measurement derived from the reference satellite within 1.25 ms.

These measurements are taken for at least 3 satellites within 1 ms. These measurements are stored according to the following Rules:

(1) Minimum records=2 satellites or the number of satellites the UT can receive.

(2) The max records=3 satellites if the UT can receive more than 3 Pilots it uses the 3 strongest.

(3) The most recent set will have at least 2 satellite records, UT discards all others.

(4) If the UT only sees one satellite then it stores only the most recent position record. In addition, the UT should store its most recent sets from multiple satellites, if they exist. In no case, the single satellite record should be discarded. The UT should thence store 3 records.

(5) When transmitting the access probe the position records must have been taken within 0.2 seconds of start of the access probe (200 ms).

(6) If the current system time exceeds the system time stamp (POS_AGE) by more than 650 sec, i.e., about 11 minutes, the UT discards the data.

(7) The UT discards data if the UT changes gateways.

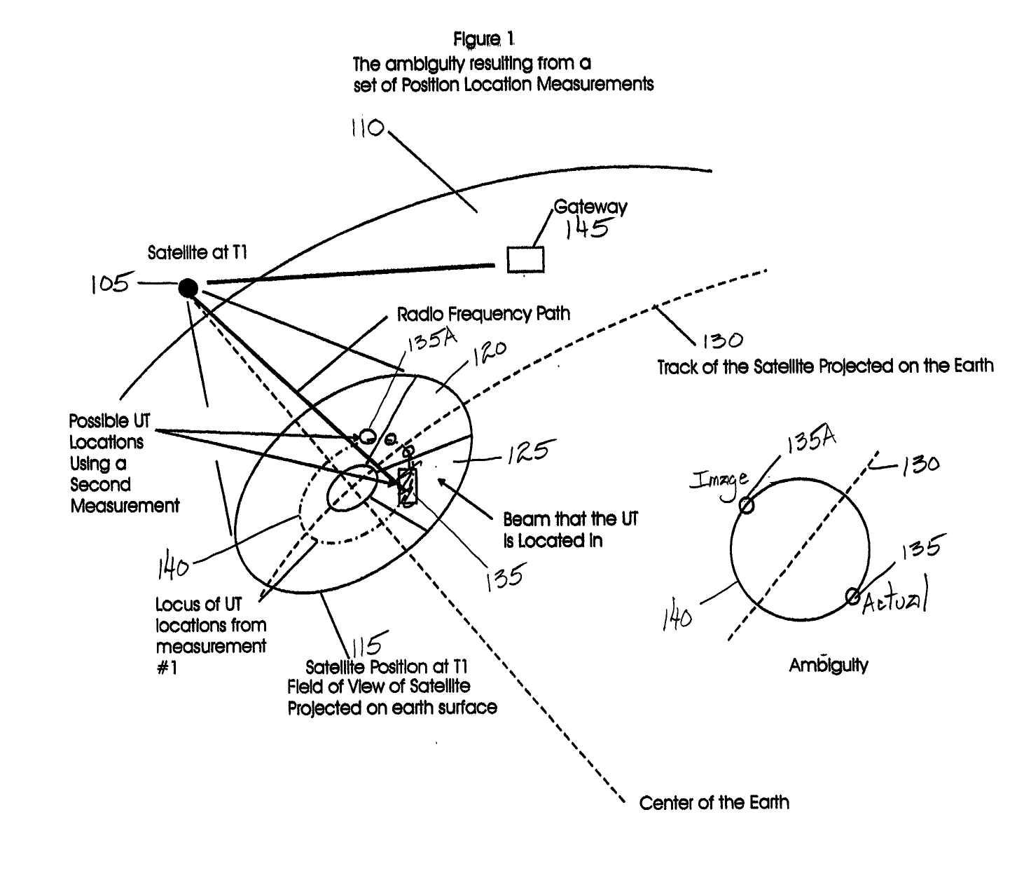

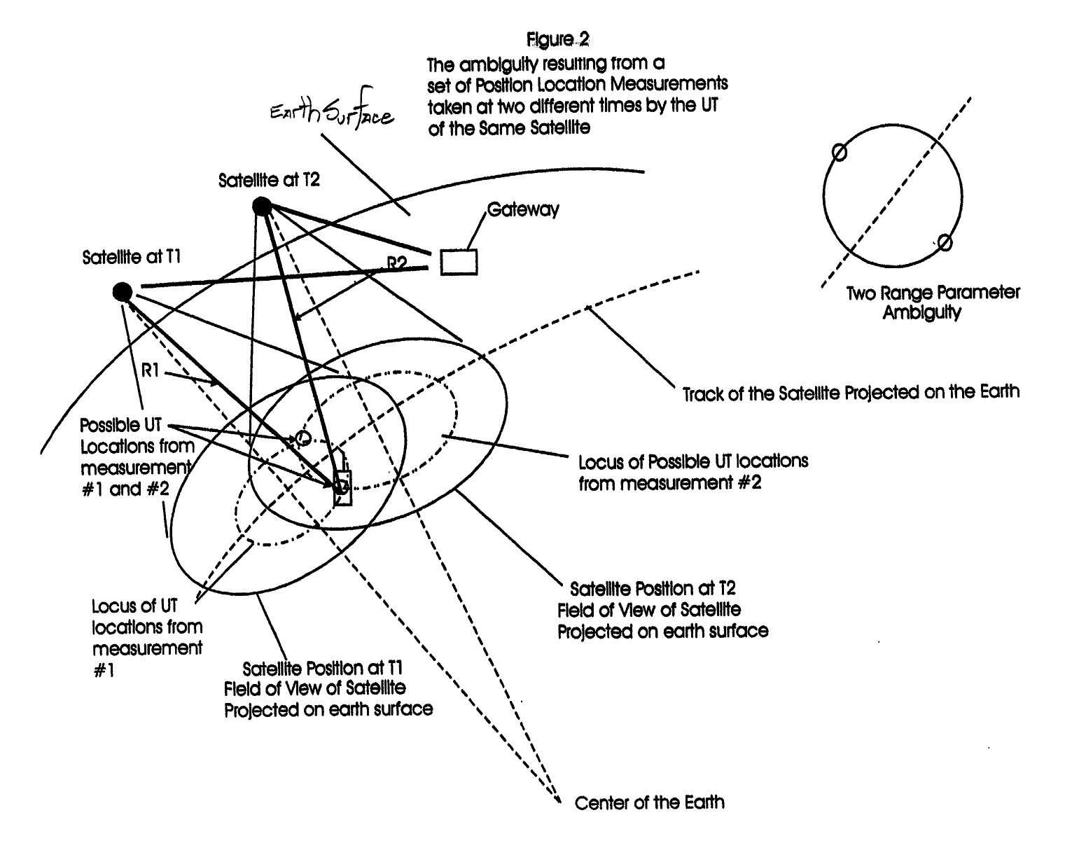

FIG. 1 is an illustration of a satellite communication system, in accordance with the present invention. A satellite 105 is moving relative to a fixed location on the ground. The satellite antenna field of view 115 and exemplary sub-beams 120 and 125 are projected onto the surface of the earth 110. The track 130 of the satellite projected onto the surface of the earth 110 is represented in FIG. 1 by a dotted line. A UT 135 desires a connection to a gateway 145.

Various means of calculating the position of UT 135 within the field of view 115 are known. Triangulation calculations are performed using a range parameter describing the distance between satellite 105 and UT 135. The range parameter represents a sphere centered on satellite 105. The possible solutions are described by the intersection 140 of the sphere and the surface of the earth 110.

By using a second measurement, the location of UT 135 can be resolved to two possible positions, that is its actual position, and the position of an image 135A.

UT 135, when operating with only one satellite visible, makes range and Doppler measurements approximately every 200 ms. There are two cases to consider. The first and most common case is that there is only one satellite available at the time the range information is requested by UT 135 to be put into a registration message, and (a) previously, for a long period of time, there was one satellite available, or (b) at the time of turn on of UT 135, there was only one satellite available. The second case is one in which UT 135 had available multiple satellites, and the range data was stored for them prior to the time when only one satellite was available.

In any case the most recent set of data records that are sent with the access probe will have been measured within approximately 200 ms prior to the start of the access probe cycle. These data records, in the case of the single satellite, have a single record set of measurements.

The relevant information included in the registration message for position location is (1) The Beam ID number=BEAM ID, and (2) the record fields of the position measurements made by UT 135.

| | | |
|---|---|---|
| Case 1 Record 1 | Ref_Sat_ID | Paging Satellite = SAT_ID |
| | PN code index | POS_SAT_ID = Paging Satellite |
| | | Index |
| | Time Difference | 0 |
| | | This is zero because the only |
| | | satellite available is the |
| | | reference (paging) satellite |
| | Carrier Offset | Delta f_{c} |
| | | (Nominal Ch value-Actual Value) |
| | Time of Measure | POS_AGE = System Time |

For case 1, UT 135 sends the satellite ID, the PN code index of the satellite whose paging channel it is monitoring, the delta frequency between the nominal channel frequency and the measured frequency of the local oscillator of UT 135, along with the System Time of the measurement. This is sent within 200 ms of the start of an access probe. This record remains until the system time exceeds the value of POS_AGE by some amount, e.g., 200 ms.

Gateway 145 then uses the information sent by UT 135 and combined with the information on satellite position known by gateway 135 calculates the position of UT 135 using both a range and range rate calculation.

FIG. 2 is an illustration of a satellite communication system showing an ambiguity resulting from a set of position location measurements taken at two different times by a UT of a satellite. The ambiguity can result from the measurement of the range of the UT with respect to the satellite in view using a measurement of two different times by the UT of the same satellite. At T1 the UT makes a position location reading of the orbiting satellite overhead. It forms a locus of UT locations which is a circle or ellipse on the surface of the earth. At a second time, at a period of time=delta time, the UT makes a second measurement. This results in a second overlapping circle or ellipse. The resultant intersection of the two circles or ellipses results in two likely positions of location for the UT. This is called a two-range ambiguity.

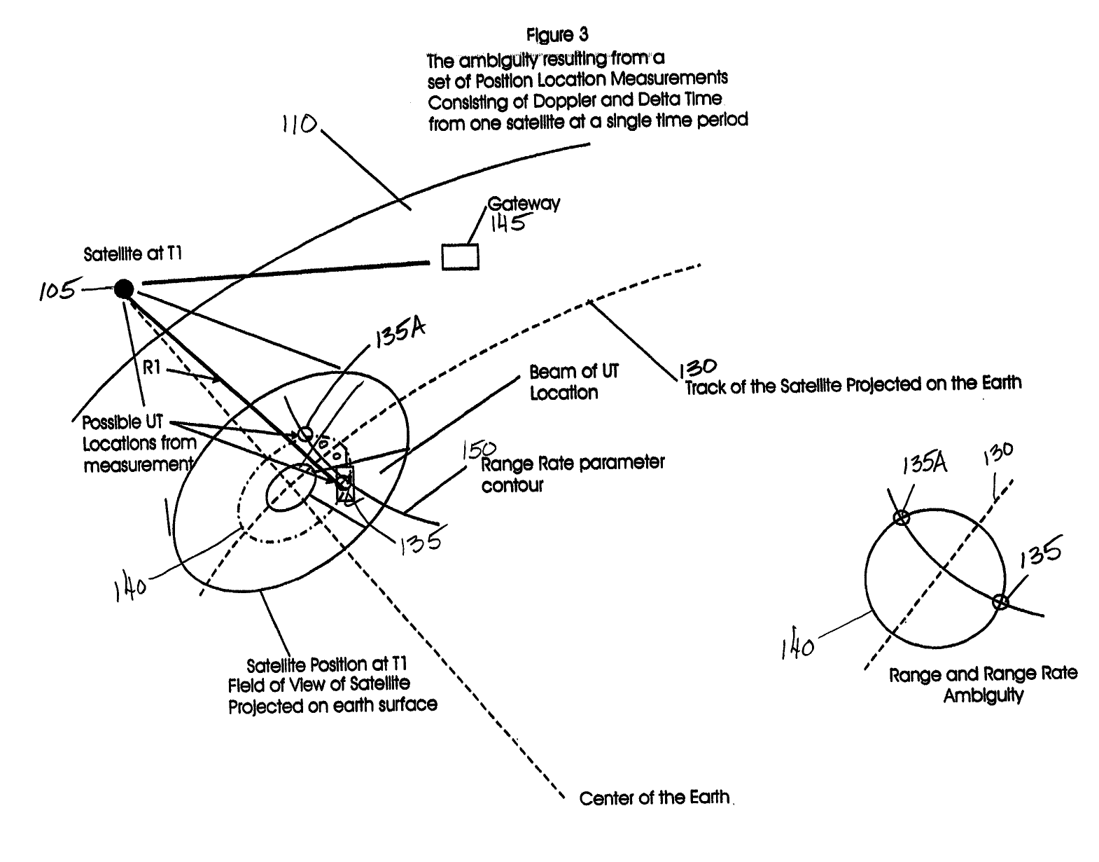

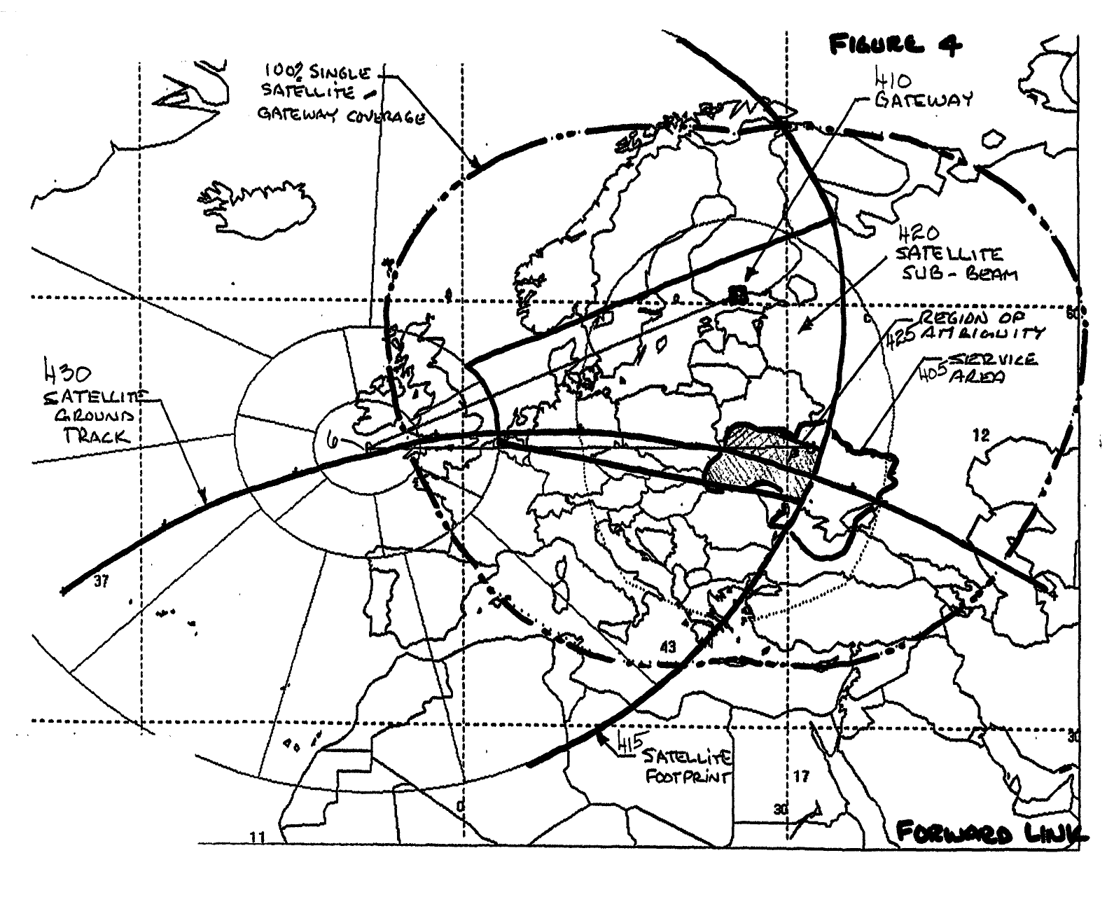

FIG. 3 shows that in a situation with a single satellite, a range and range rate calculation can be used to further resolve a location of a UT. More specifically, a range and range rate parameter contour 150 indicates that the position of UT 135 can be at either of two points along intersection 140, namely the actual position of UT 135 or at the image position 135A. To resolve this ambiguity, UT 135 uses the information sent in the registration message to determine which of the position locations, 135 or 135A, is correct. This is sufficient for most cases. However, if the two ambiguous positions lie in the same sub-beam of satellite 105, typically caused by UT 135 being at long range from gateway 145, and in a location near the satellite track 130, then the position location calculation fails, and the UT is not registered.

High rates of position location failure, and thus a higher than normal non-registration events, i.e., registration failure, in certain gateways can be traced to position location failure due to the UT being in a location, or a location/propagation environment, that yields only single satellite coverage for the 200 ms, or some other specified time, prior to the request for service.

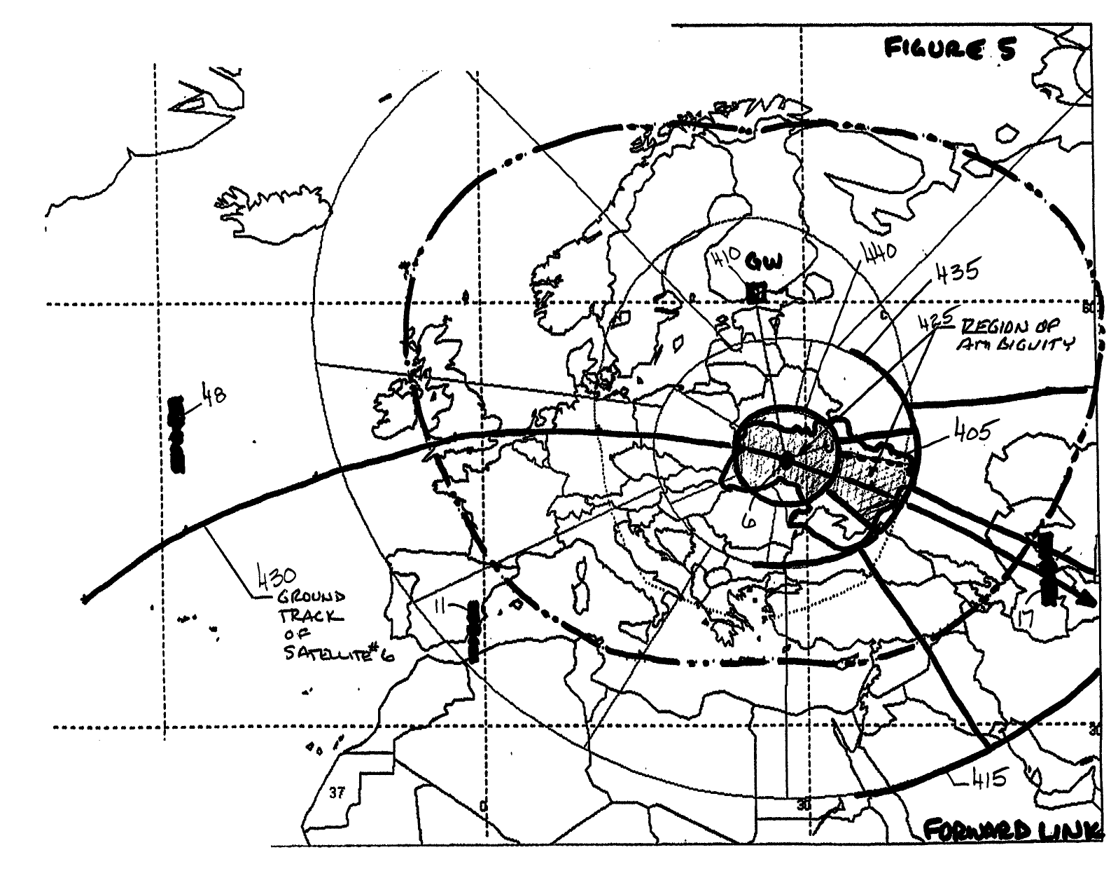

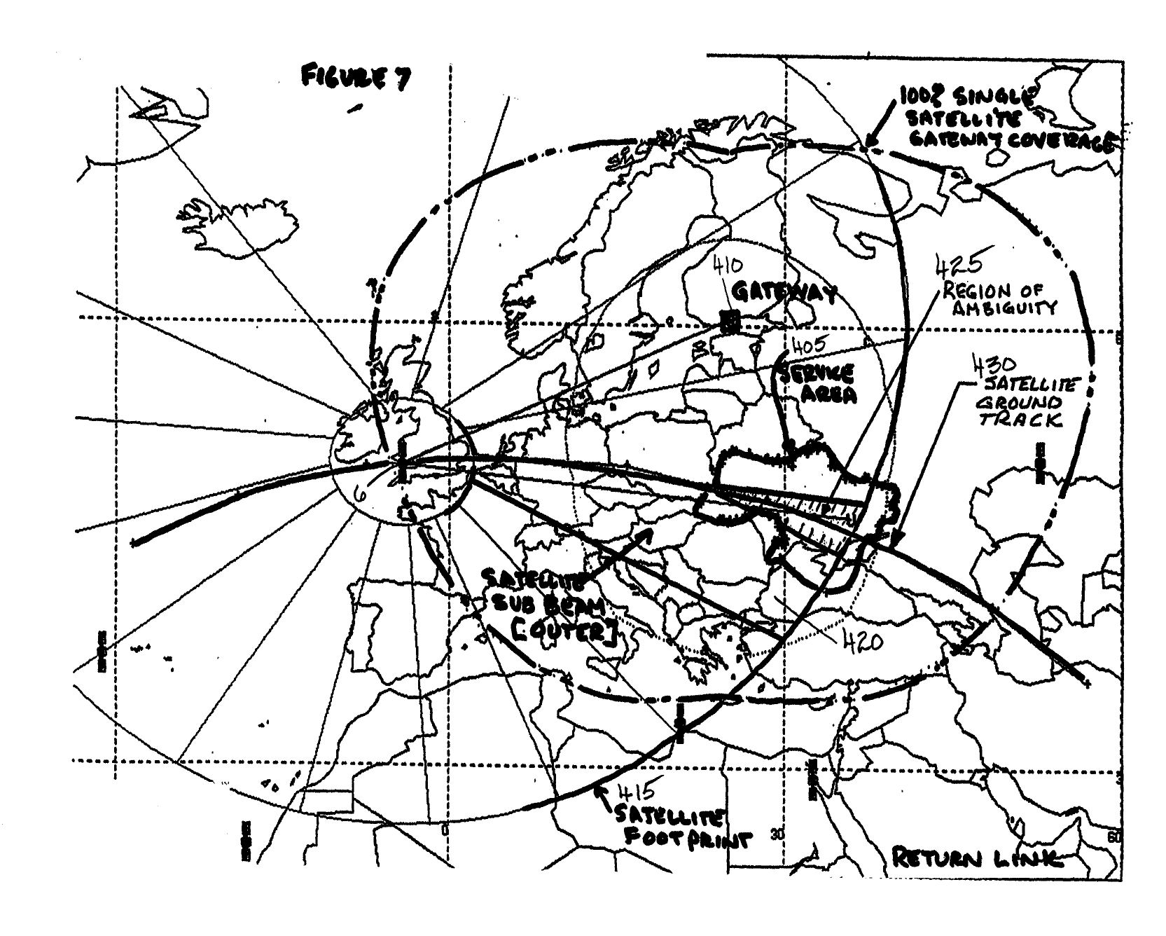

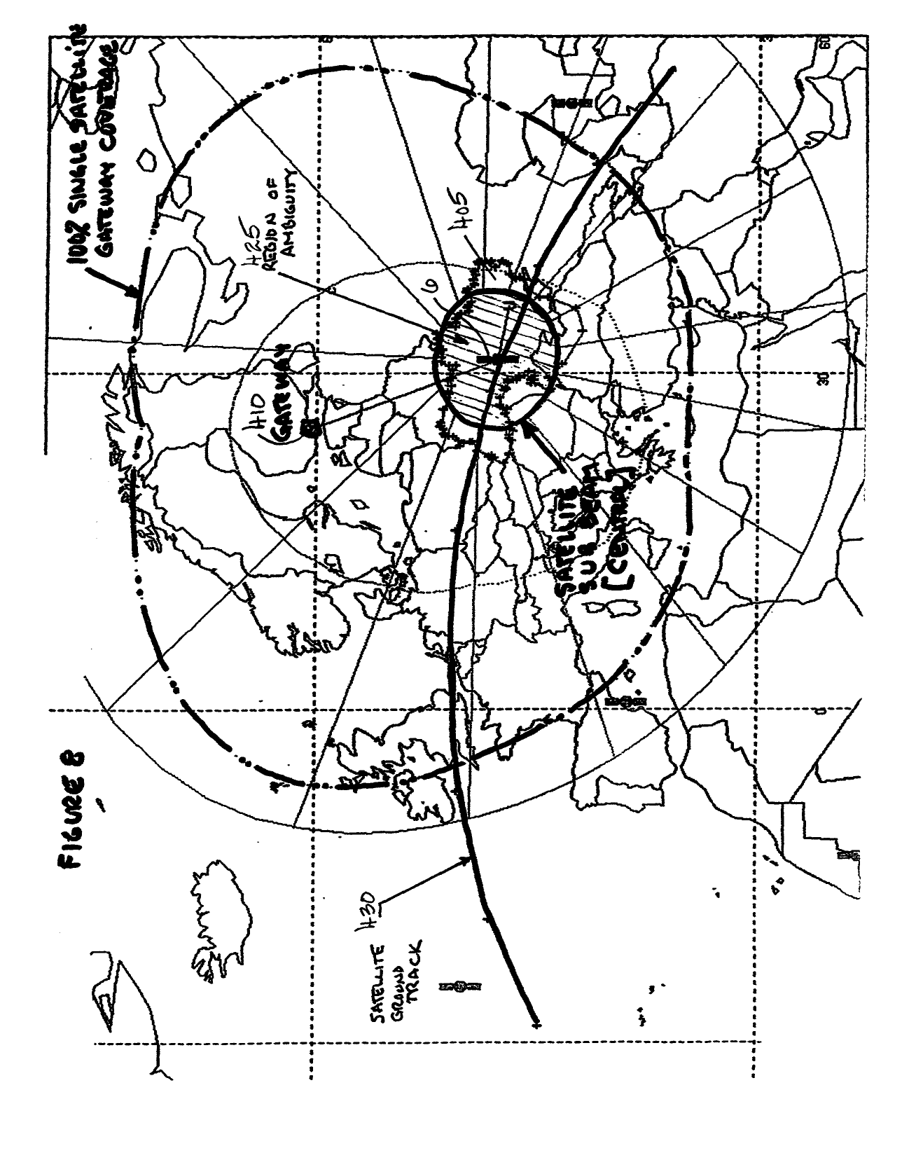

FIGS. 4, 5 and 6 are maps showing how registration failure can occur in a portion of a service area. These figures are from a single pass of a satellite 6 over a service area 405.

A gateway 410, i.e. the Karkkila Gateway, serves the Ukraine. In FIG. 4, gateway 410 has been in communication with service area 405 for about 2 minutes. The antenna pattern 415 on the ground is that of a forward link from gateway 410 to a UT (not shown). The UT is reporting a beam number of satellite 6 to gateway 410 using a reverse link. The satellite beam is covering about ½ of service area 405 in the Ukraine. In a particular implementation, the beam from satellite 6 is defined as a “sub-beam” 420 based on a signal frequency.

In a symmetric region lying within sub-beam 420 and equidistant from the satellite ground track 430 there is formed a region of ambiguity 425. If satellite 6 is the only satellite covering service area 405, then region of ambiguity 425 is formed and it will grow as satellite 6 moves eastward.

The problem area lies along the ground track 430 of satellite 6. There may be other satellites available to the UT, however, if these satellites do not have co-visibility to gateway 410, or if the propagation path to the other satellite is blocked by buildings, the problem condition applies. Even when other satellites are co-visible to gateway 410, gateway 410 must switch to these other satellites. Also, there is a low probability of having 3 satellites co-visible to gateway 410 when the UT is very far from gateway 410.

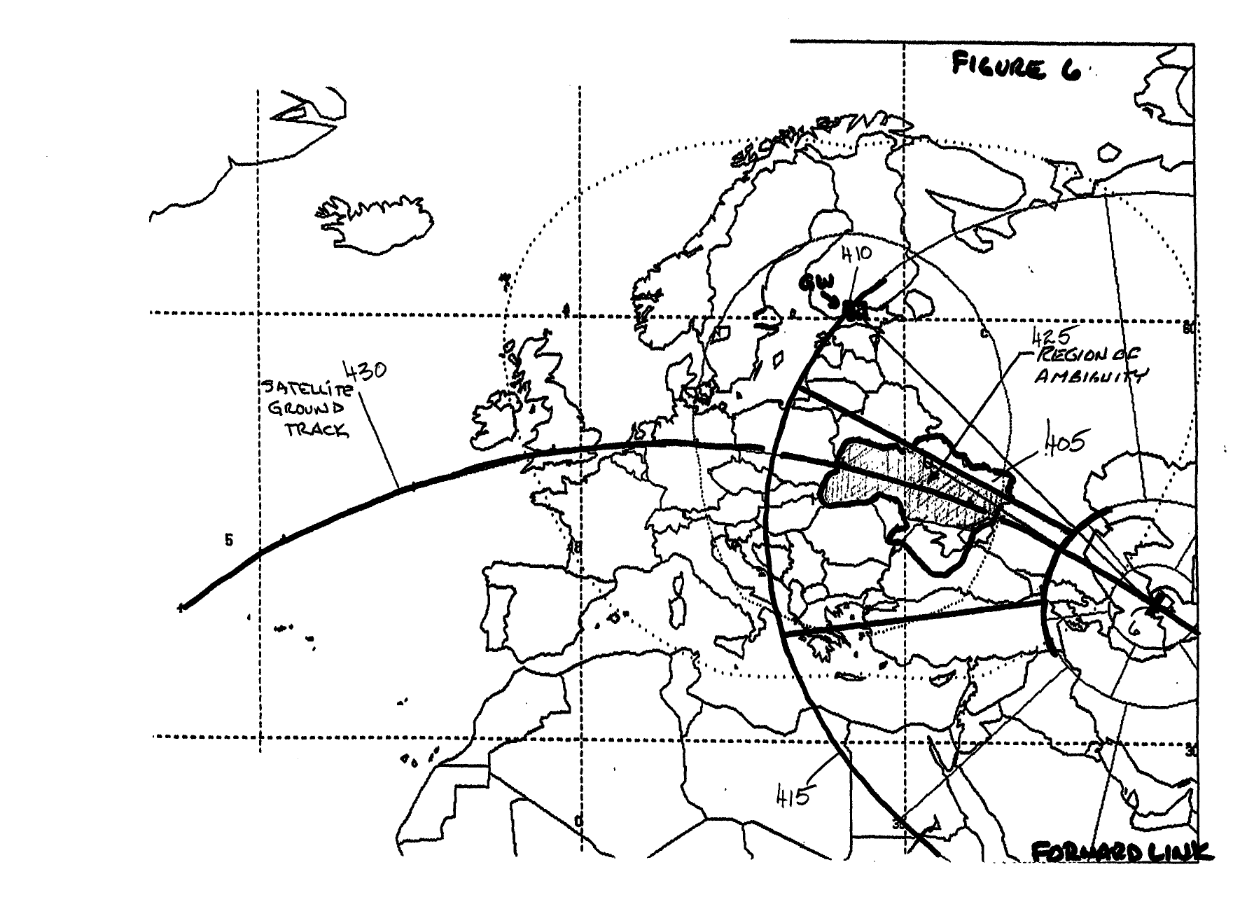

As shown in FIG. 5, the situation worsens when the middle beam 435 and inner beam 440 of satellite 6 pass over service area 405, the region of ambiguity 425 grows to include nearly all of service area 405. Note that both middle beam 435 and inner beam 440 are affected. These conditions continue until satellite 6 no longer can communicate with gateway 410.

The total time of single satellite ambiguity impairment for this pass was about 15 minutes. As shown in FIG. 5, service area 405 is entirely served by satellite 6, and satellites 11, 17, and 48 are not yet in communication with gateway 410 at Karkkila.

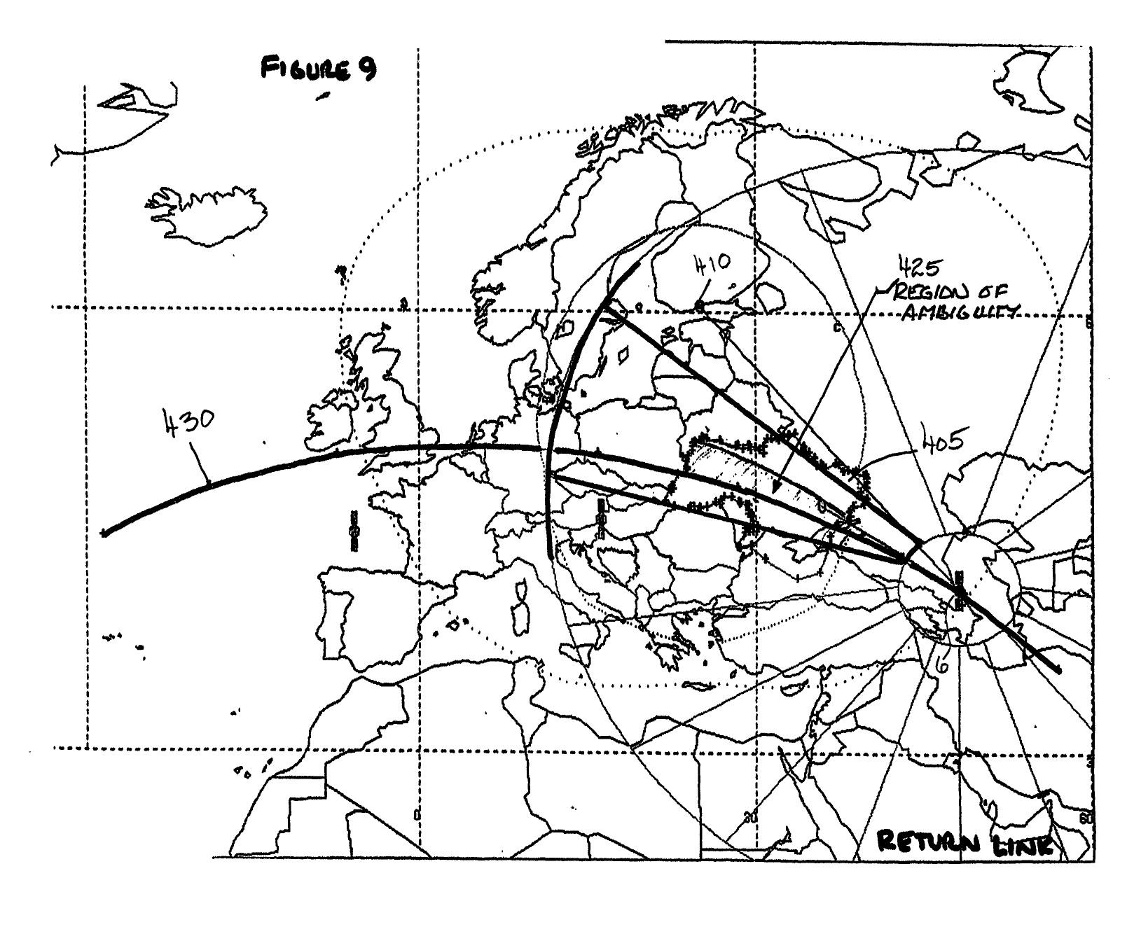

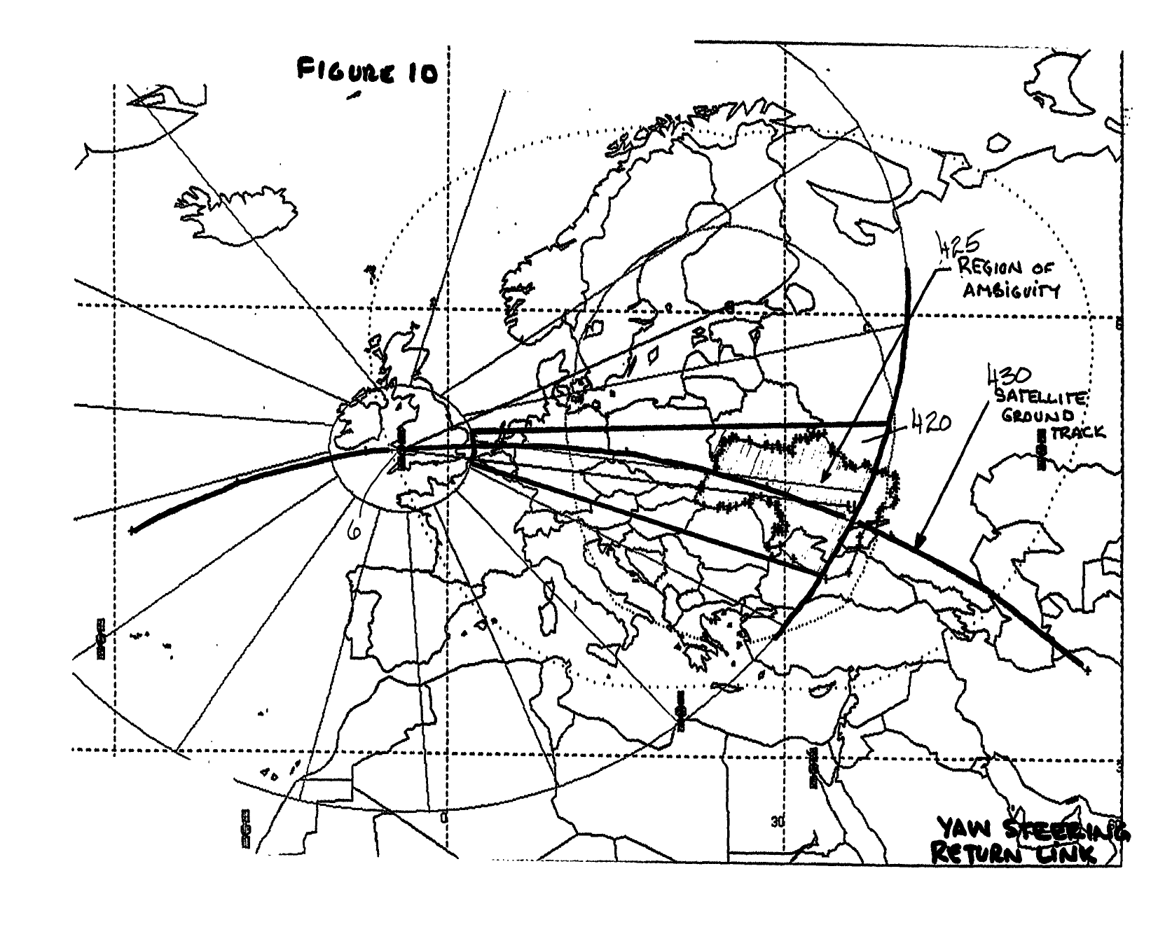

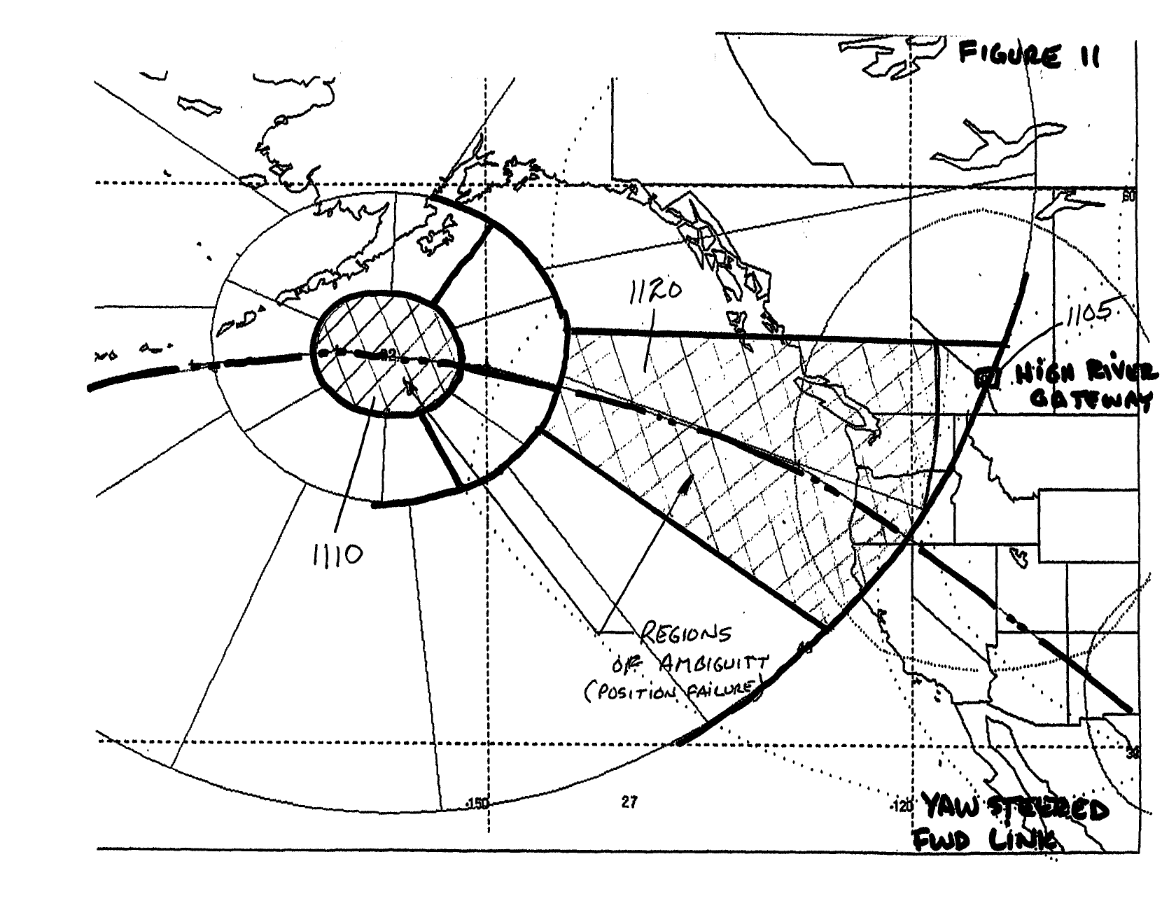

FIGS. 7, 8 and 9 depict the situation of FIGS. 4, 5 and 6, using the return link beam configurations. The same phenomena exists, therefore using a return link beam ID will not solve the problem.

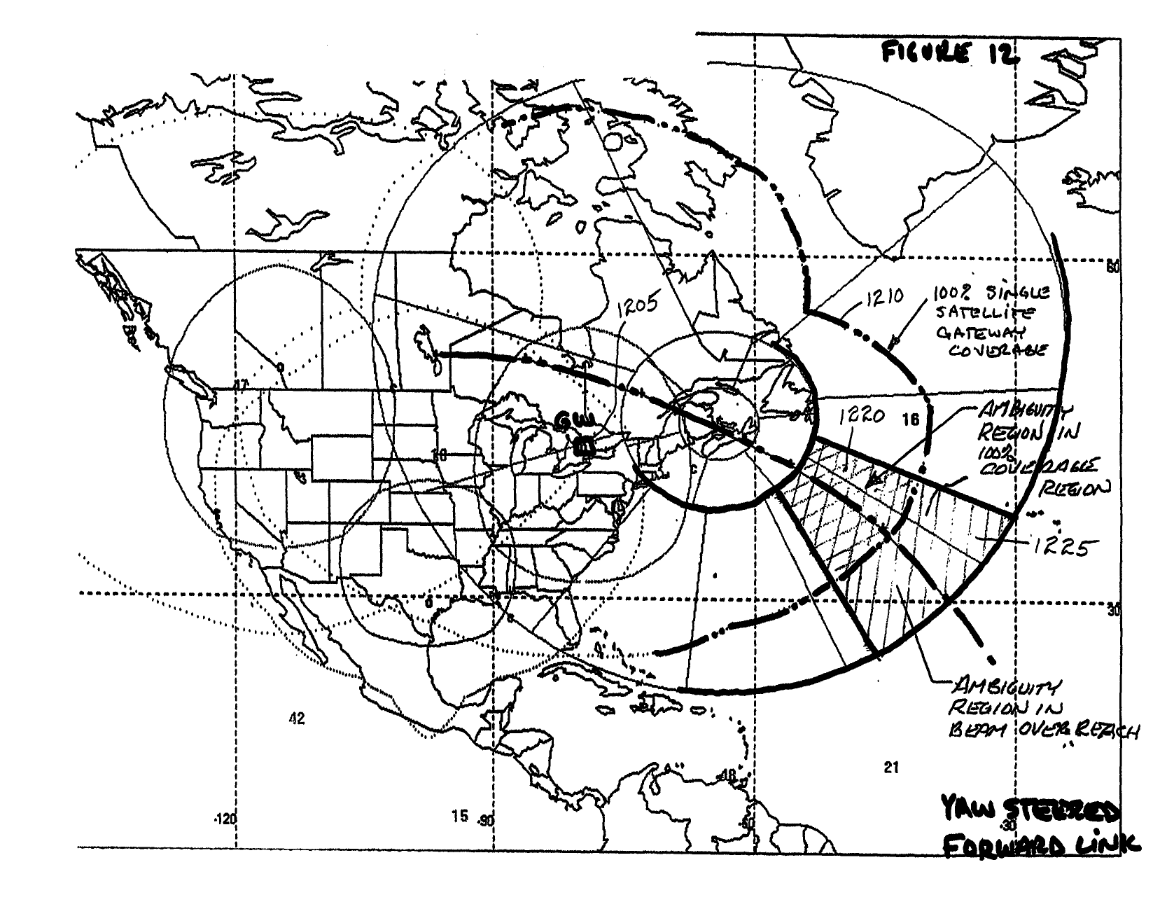

FIG. 10 shows how the ambiguity problem is aggravated by the use of yaw steering. During certain times satellite 6 is rotated in yaw in order to keep its solar panels pointed at the sun. At these times sub-beam 420, shown in a first position in FIG. 7, may be rotated as shown in FIG. 10. This rotation substantially increases the size of ambiguity region 425. The Karkkila gateway serving the Ukraine will experience the ambiguity condition position failure about 30% of the time independent of the local conditions of a UT. Local conditions of the UT will increase the number of position location attempts that will result in an ambiguity. This occurs, for example, when the UT is behind a building or other obstruction that prevents a line of sight to a second satellite. Other areas and gateways will also experience this problem, especially those employing BOR to enlarge their service areas.

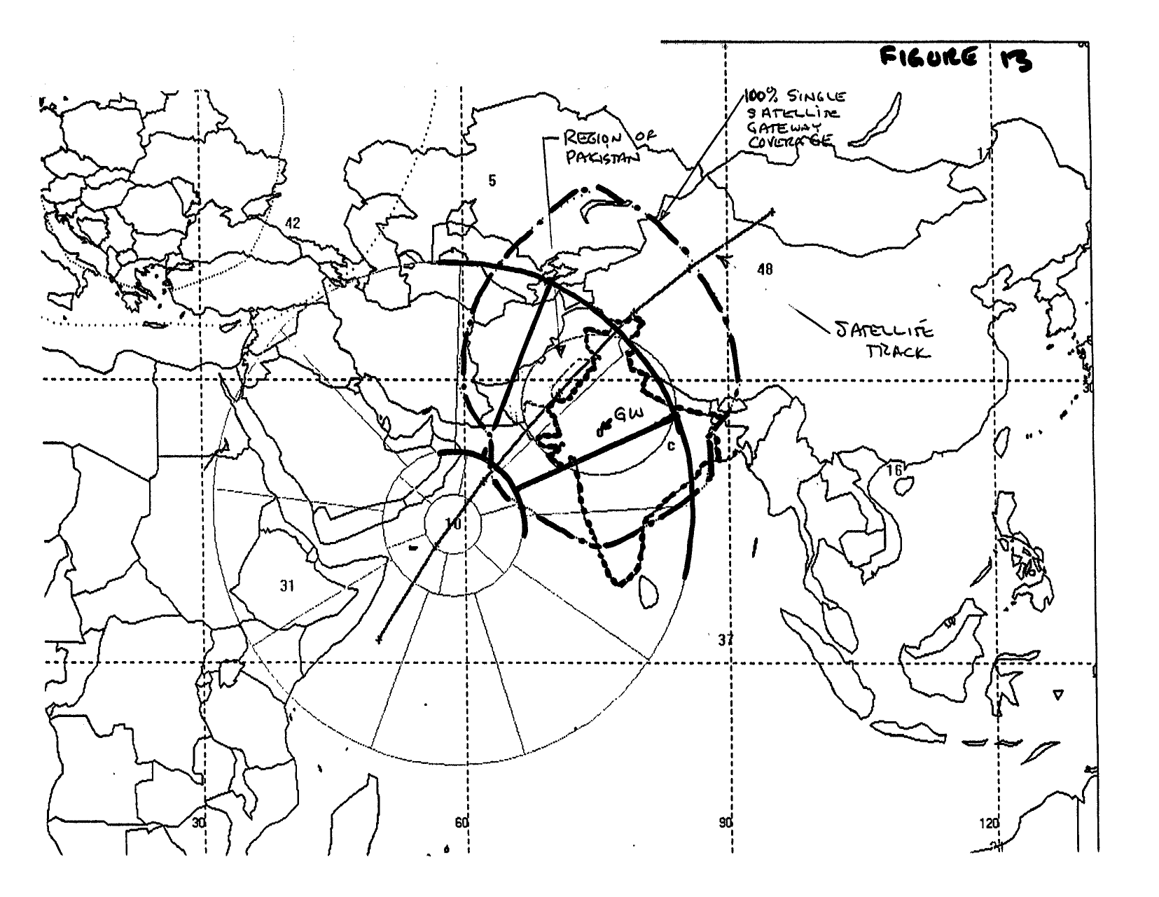

FIG. 11 shows a gateway 1105, i.e., the High River gateway, serving a “beam over-reach” area with two zones of ambiguity 1110 and 1120, in which position location failure can occur. Zone of ambiguity 1110 formed by the central beam is outside of the single satellite coverage, therefore increasing the perception of the user as to lack of service.

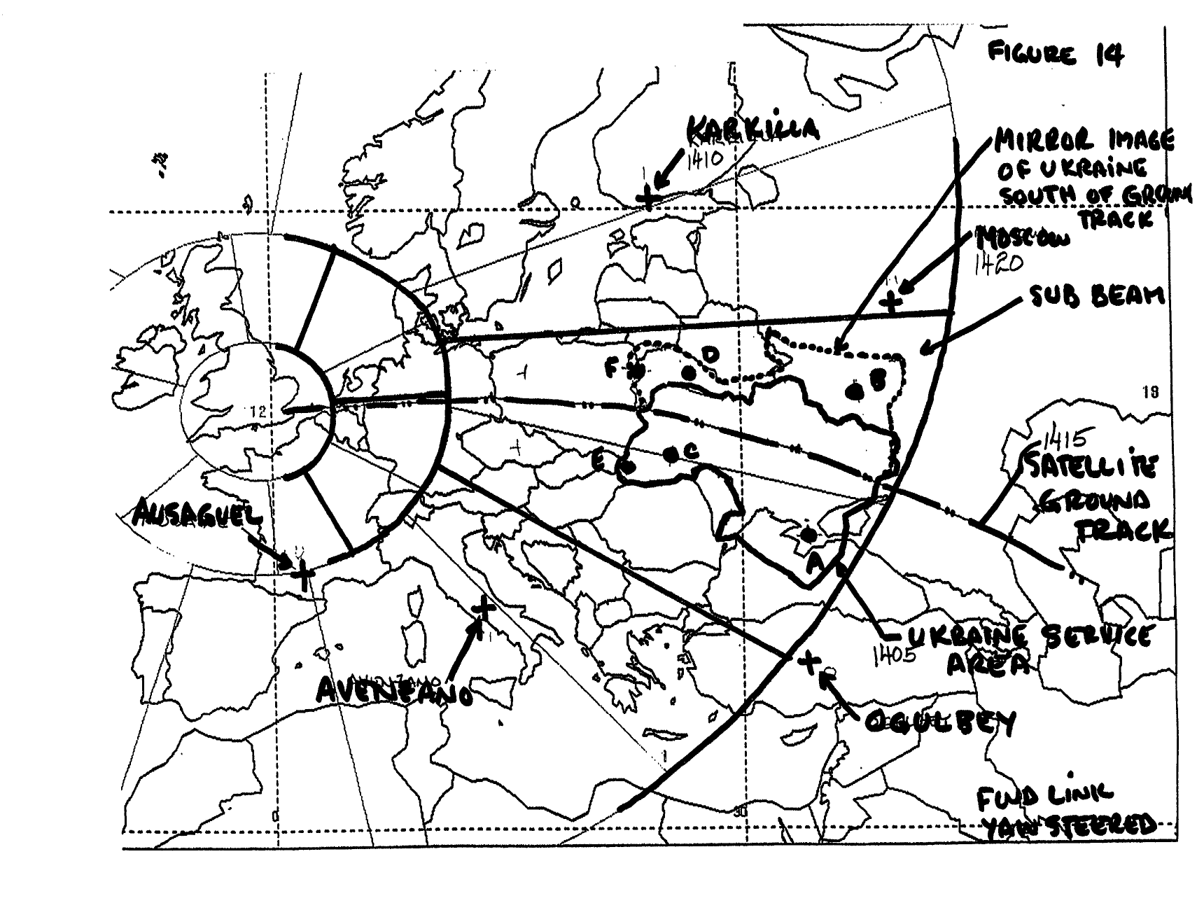

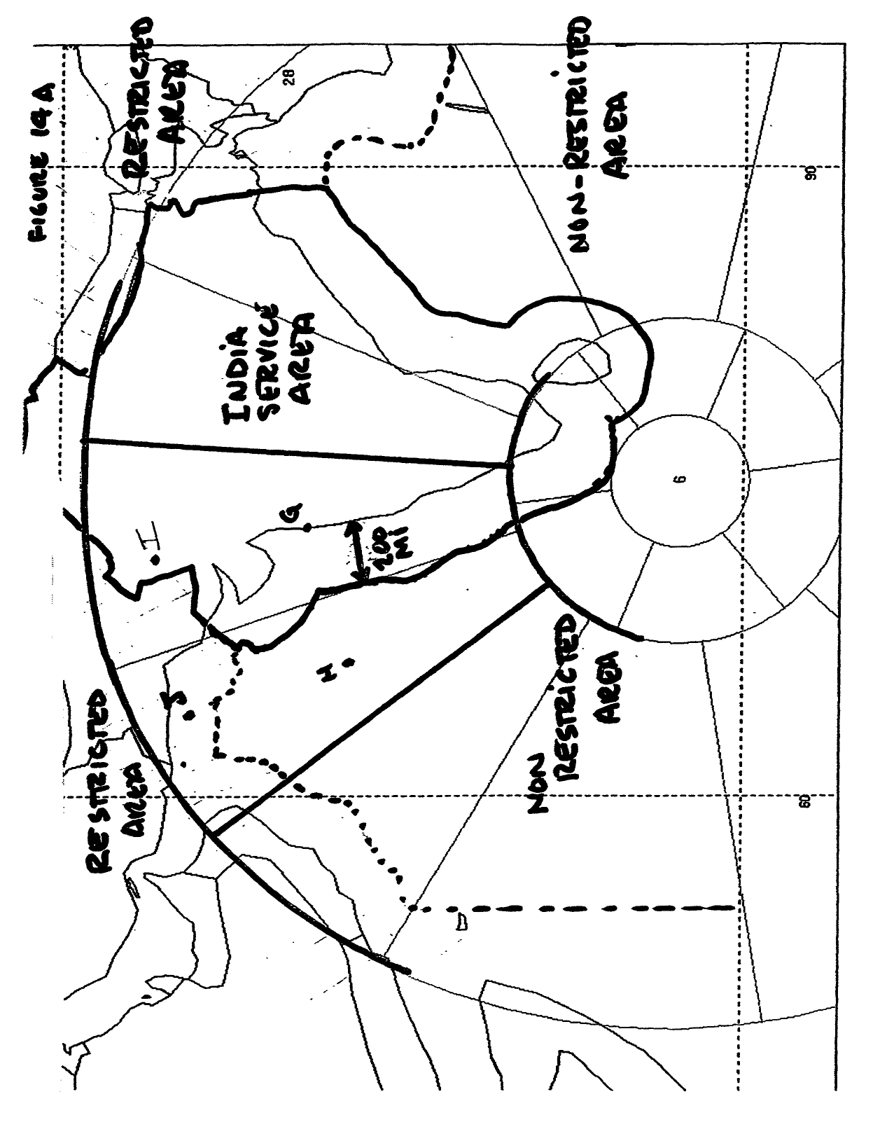

FIG. 12 is illustrative of a similar situation in the Atlantic Ocean “beam over-reach” area being served by a gateway 1205, i.e., the Smith Falls gateway. In this case a single beam has ambiguity in both zone 1220, which is in the 100% single satellite gateway coverage region 1210, and in zone 1225, which is in the extended “beam over-reach” area where there is less than 100% coverage.

A UT may take one or more of several actions due to ambiguous position failure. Note that in the following discussion, all of the times are “representative” and do not change the conclusions. Position location measurements are made within 200 ms of an access probe for “power-on” registration, reregistration by gateway command, traffic origination, and for a page response message, channel request message, sent by the UT. In addition, the gateway can order a position location measurement to which the UT responds with a position location measurement. The UT can request a position location calculation by the gateway by sending a position request data message.

If the gateway calculates an ambiguous position due to the UT measurement data contained in a registration message or a re-registration by gateway command, traffic origination or page response message, the Gateway takes the following actions;

(A) Actions in a registration message when gateway declares ambiguous position. A Release Order Message Record is formed that includes the information shown in Table 1.

TABLE 1

| | | |
|---|---|---|
| ADDRESS | UT Address | This identifies message |
| | | to the user |
| ORDER | Order Code | Set to type of Order GW |
| | | wants 010101 = Release |
| | | Order |
| ADD_RECORD_LEN | Additional | Set to number of octets in the |
| | Record length | order specific field |
| ORDQ | Order Specific | Set to condition required |
| | field | 00000000 = No reason given |
| | | 00000001 = Invalid SP |
| | | selected |
| | | 00000010 = Service Opt. |
| | | Reject |
| | | 00000011 = Not in Service |
| | | Area |
| | | 00000100 = ETSI update reqd |
| | | 000lnnnn = Deferred Access |

For the ORDQ field, nnnn=number, where this number multiplied by 20 seconds yields deferment time in seconds.

The gateway declares a position location failure and prepares a Release Order Message with the value of ORDQ field set to 0000nnnn, about 20 seconds. This means that the UT is able to retry the tried gateway after 20 seconds. During the interim it is possible for the UT to search for and try to acquire other gateways. If it finds another gateway's pilot it will attempt a registration. Depending on the setting of permissiveness of that gateway either the UT will be logged on or rejected once again only if the UT is in the Service Area of the GATEWAY or if the position location is ambiguous and the GATEWAY is permissive. If the gateway is set to permissive and that gateway yields an ambiguous position location, and the UT is a GSM type, the UT will find no valid SP, but will be allowed to log on as an emergency user only. In this case the user may find that the UT may not be usable for an extended period of time. If the UT does find a valid SP, but there is no roaming agreement, since the UT is in a roamed to area, but the gateway is allowing calls, there will be an invalid billing. After the 20-second (first gateway) timer expires the terminal will be free to try the original gateway once again.

(B) Actions in a traffic origination or page response message when gateway declares ambiguous position.

The gateway declares a position location failure and prepares a Release Order Message with the value for ORDQ field set to 0000nnnn where nnnn is set to 20 seconds. The idea is that the user will, within 20 seconds, move the UT to a location that will be open to another satellite, or that the constellation will move to un-block a currently blocked UT. However, the problem may persist if the user does not move, or if there is still only one satellite available, e.g., if the UT is in an urban environment with significant blockage. The UT is notified that the system is not available for a traffic origination message or the caller is notified that the UT is not available for a page response message.

Provided below are several methods for resolving ambiguity, in accordance with the present invention. One or more of these methods may be employed as a solution, and may be practical for a particular gateway. Some gateways may favor one solution over another depending on the location.

Briefly, these methods include:

1) Permissive Gateway Setting.

2) Register if stored value of last service provider ID is able to be served by GATEWAY.

3) Map database enhanced registration.

4) Use of both forward and return link beam information in the gateway calculation.

5) Direct the UT to obtain additional position measurement data from the pilot of another satellite with the pilot being sent from a different gateway.

6) Direct the UT to obtain additional position measurement data from satellites that are visible to itself but not to the gateway.

7) Send Satellite Ephemeris information to the UT for it to calculate its position based on both of the ambiguous positions after measuring the range to the new satellites, then report position to the gateway

8) Use the pilot from a third satellite that is visible to the UT, but not necessarily to the gateway.

9) Use another gateway to measure and report the range and Doppler and calculated position (including ambiguous locations) of a UT which attempts to register after being deferred to another gateway.

10) Having the gateway store the position of UTs and if a successful measurement was done “recently” use that measurement or a region to resolve the ambiguity.

A first method in accordance with the present invention provides for permissive gateway setting that allows the gateway to register a UT even if an ambiguous position is calculated.

There are several circumstances in which this method is not the most suitable.

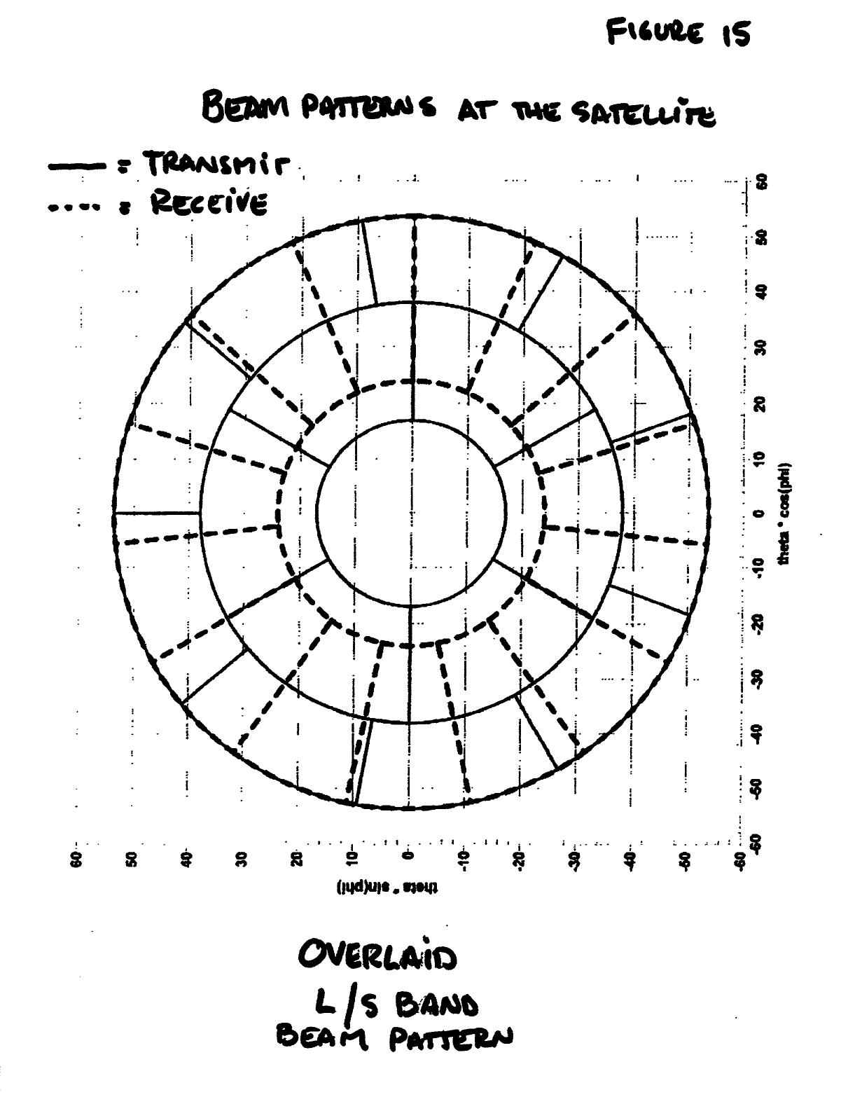

a) UT may be in a territory not served by any Service Provider. The territory may be “non-friendly”. FIG. 13 depicts this condition.

In this example a gateway in Northern India is in contact with satellite #10. The beam from this satellite gives ambiguous positions in both Pakistan and in India. A permissive gateway would register a UT located in Pakistan. Calls are possible periodically with this registration.

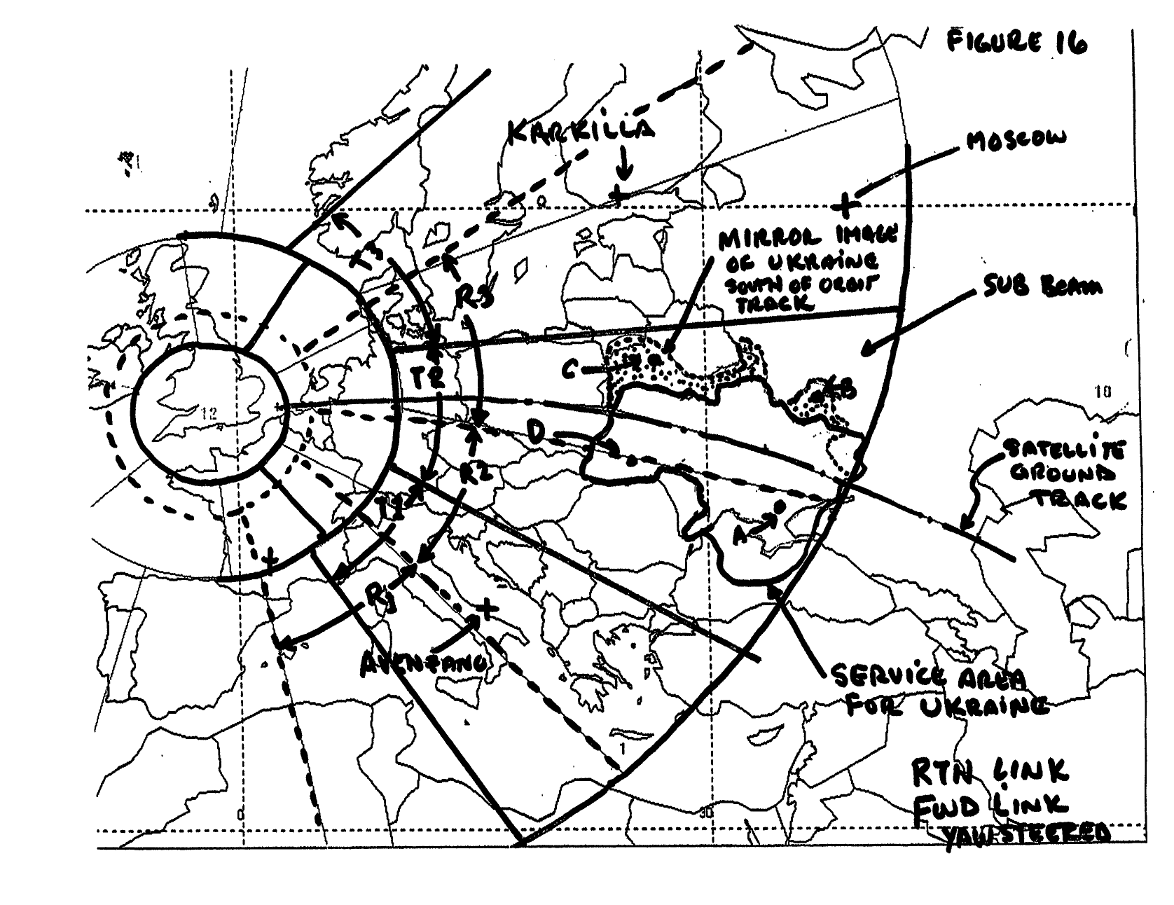

b) UT may be in a territory served by a different service provider using a different gateway. The territory could be a different service provider, such as SP#1 and SP#2 (the gateway registering the UT). FIG. 14 depicts this condition. A UT in “Yugoslavia”, i.e. any of the old “Yugoslavian countries”, Bulgaria, Albania, the Adriatic Sea or a portion of Italy that finds the Karkkila pilot first, before the Italian gateway, would appear to be at the ambiguous location in the Ukraine and would be registered to the gateway at Karkkila.

c) UT may be in a sub-region within a Service Area assigned to a certain Service Provider and be registered with the wrong sub-region supplier, even with the UT located within a single Service Area.

Take for example the condition shown in FIG. 11. The High River Gateway 105 could be serving Alaska and the waters south of it. The ambiguous locations that would be generated as shown in FIG. 11 would not necessarily be a problem. As long as the gateway remained permissive it would not be a problem. Note: if many users of the system were users of Position Location data delivered to the user a different problem arises, since the gateway cannot reliably calculate the position. On the other hand, if the waters of the Gulf of Alaska were served by a different Service Provider this could be a problem. On the other hand, at the time that the UT was registered in the wrong gateway due to “permissiveness” the satellite constellation may have been temporarily advantageous for communications, the remainder of the time the user may be disadvantaged and obtain poor service.

A second method of the present invention provides for registering a UT if the stored value of the last service provider ID is able to be served by the gateway.

This method puts a qualifier on the registration process to allow a non-permissive gateway to register a UT if a position ambiguity is calculated by the gateway. The process involves having the gateway review, a UT sent, prior gateway registration value. The UT also has stored the Mobile Country Code (MCC) and Mobile Network Code (MNC) values of its HOME_SP. A UT at power down stores this information in semi-permanent memory. The value of the validity of the data is arbitrary, and is related to the battery condition. Since this is temporary memory, it is lost when the battery is discharged. These fields are shown in Table 2.

TABLE 2

| | | |
|---|---|---|
| REG_GW | GW identifier of last | Valid for 48 hrs after |
| | GW registered | power off, if integrity |
| | | bad then is set to NULL |
| | | at power on |
| REG_MCC | Mobile Country Code of | Valid for 48 hrs after |
| | last registration | power off, if integrity |
| | | bad then is set to NULL |
| | | at power on |
| REG_MNC | Mobile Network | Valid for 48 hrs after |
| | Identifier of last | power off, if integrity |
| | registration | bad then is set to NULL |
| | | at power on |
| REG_LAC | Last Used Location Area | Valid for 48 hrs after |
| | | power off, if integrity |
| | | bad then is set to NULL |
| | | at power on |

The UT has received from the Gateway Service Provider Message, which is broadcast on the Paging Channel, the information shown in Table 3.

TABLE 3

| | | |
|---|---|---|
| SERV_MCC | SP Mobile Country Code | The three digit code for |
| | | the SP |
| SERV_MNC | SP Mobile Network Code | The code for the SP |
| SERV_TYPE | Service Type of this SP | The type of service |
| | | offered |
| | | 00 = no service |
| | | 01 = IS-41 |
| | | 10 = GSM |
| | | 11 = Both IS-41 and GSM |

At power up, in the initialization state, the UT performs the actions indicated in Table 4.

TABLE 4

| | | | If this | |
|---|---|---|---|---|
| Step | Function | Result | is true | Note |
| 1 | Copy REG_GW | REG_GW = Last | Power Up | Last GW used |
| | fm SIM | registered | | |
| 2 | Copy MCC, | Values = Last | If valid | Provide last |
| | MNC, DIGIT_{—} | registered | on SIM | stored info |
| | TMODE fm SIM | | | to active |
| or | Set REG_GW | to NULL | If not | REG_GW = |
| | | | valid data | none |
| 3 | Set update | U1 (updated) | If REG_{—} | Means normal |
| | status to | | GW not | service |
| | | | NULL | |
| or | Set update | U2 (not | If REG_{—} | Attempt to |
| | status to | updated) | GW is | update |
| | | | NULL | |
| 4 | Set | NO | For all | Forces |
| | REGISTERED | | cases | registration |
| | flag | | | |
| 5 | Enable | T₅₇ = 20 sec | For all | Allows 20 sec |
| | powerup | | cases | to reg |
| | Init. = | | | |
| 6 | Set | NO | For all | Timer based |
| | COUNTER_{—} | | cases | registration |
| | ENABLED | | | |
| 7 | Set | NO | For all | Autonomous |
| | REG_{—} | | cases | reg status |
| | ENABLED to | | | |
| | | If switching from | Upon | |
| | | any other mode | switch | |
| | | (terrestrial) | of mode | |
| 1 | Set | NO | | Timer based |
| | COUNTER_{—} | | | registration |
| | ENABLED | | | |
| 2 | Set | NO | | Autonomous |
| | REG_{—} | | | reg status |
| | ENABLED to | | | |

At initialization the UT copies REG_MCC and REG_MNC from the SIM to the active memory of the UT. The UT then enters the Custom Gateway Selection Process. The UT should select the gateway from among the gateways listed in the Sync Channel Message, but the particular procedure for doing this is left to the discretion of the UT manufacturer. In general the UT performs the following.

(a) If the value of SERV_MCC and SERV_MNC are equal to the MCC and MNC values derived from the UT stored field HOME_SP then the gateway is chosen.

(b) If the value of SERV_MCC and SERV_MNC are equal to the UT last stored value from the SIM of REG_MCC and REG_MNC the gateway is chosen.

(c) If neither of these conditions are fulfilled then the UT can select from the list of gateways it has developed. In the case of an ambiguity, generally, the values of SERV_MCC and SERV_MNC are transmitted by the gateway on the paging channel.

The UT then sets REQ_MCC and REQ_MNC in the Registration Message to one of the following;

(a) SERV_MCC for Case A. A UT's return to the service area from elsewhere.

(b) REG_MCC and REG_MNC for Case B. UT has not moved from last service area.

(c) SERV_MCC for Case C. The gateway transmitted values on the Paging Ch.

The gateway using this solution after a position ambiguity failure attempts to register the UT with the value of REQ_MCC and REQ_MNC transmitted by the UT. If the value of REQ_MCC and REQ_MNC are equal to the gateway service provider the UT is allowed to register. This approach works for most cases, considering that users mostly call from within their own territory, or roamers stay within a territory making several calls.

However, this technique is not the best one suitable for roaming UTs. Also the data stored in the UT SIM card may be corrupted or non-existent. In one implementation, the semi-permanent values stored in the SIM are only valid for 48 hours. This condition may be caused by the battery in the UT running out of energy or the user removing the SIM card or the battery.

Referring to FIG. 14, an example pass of a satellite 12 is shown. It is possible that the sub-beam could lie along the orbit track, making all of the Ukraine in single satellite coverage. While this condition will not always occur, it helps to illustrate the issue. Lesser degrees of severity of the following will occur more frequently. In this example, satellite 12 is covering the Ukraine service area 1405, the other satellites are not able to “see” the Karkkila gateway 1410.

The initial measurement of range and calculation of position yields an ambiguous result showing two positions as “mirror images”. North of the ground track 1415, a mirror image is formed of the portion of the Ukraine Service area 1405 south of the ground track 1415. South of the ground track 1415 a mirror image is formed of the portion of the Ukraine north of the ground track 1415. For clarity, only the northern mirror image is shown in FIG. 14.

UTs are shown at A or B, C or D, and E or F. In this example, there could actually be a UT at A. After a calculation by the Karkkila gateway 1410, the location of UT A would only be known as A or B due to ambiguity. Likewise, the UT could actually be at B, and its image would appear at A.

Case 1: Using this method, a non roaming UT located at A with an image at B, would be assumed to be in the Ukraine Service Area 1405 and would be accepted by the Karkkila gateway 1410 if it had last registered with the Karkkila Gateway 1410. If the UT had last registered in the Ukraine the result would be acceptable. If the UT had just roamed to the Ukraine and its last registration was elsewhere, or if its last registration stored on the SIM was corrupted or non-existent the result would be unacceptable and the UT would be rejected. The UT would seek another gateways. Since the UT is truly within the Ukraine, the other gateways will reject the UT.

In one implementation, since the other gateways would reject the UT, ultimately the UT would return to try the Karkkila gateway once again. If this happens 4 times, the Karkkila gateway will signal the UT to defer any further registration for up to an hour. This timer may be set to other values.

Case 2: A UT is at B in Russia and is not roaming. The UT image is formed at A. The last registration is of the Moscow gateway 1420. The Karkkila gateway 1410 cannot match the last registration with its service area and therefore rejects the UT. The UT then seeks other pilots, ultimately finding the Moscow gateway 1420, at which the UT is accepted. This result is acceptable.

Case 3: A UT is roaming to the Ukraine and is located at A with an image at B. Since its last registration is not in the Ukraine the Karkkila gateway 1410 rejects the UT. Since the UT is truly in the Ukraine all other gateways reject the UT.

Case 4: A Ukrainian UT has roamed to location B in Russia. Since its last registration is in the Ukraine, the Karkkila gateway 1410 assumes that it is still in the Ukraine and registers the UT as being there. The registration is therefore at the wrong gateway.

Table 5 indicates the result of various roaming and non-roaming conditions at this orbit time.

TABLE 5

| | | Last | | | | | Desired | |
|---|---|---|---|---|---|---|---|---|
| User | Roam | Reg | Actual | Image | Pilot | Reg GW | GW | Result |
| A | No | Ukraine | Ukraine | Russia | KAR | KAR | KAR | OK |
| B | No | Russia | Russia | Ukraine | KAR | MOS | MOS | OK |
| A | Yes | Any | Ukraine | Russia | KAR | NONE | KAR | Bad - User Rejected |
| B | Yes | Ukraine | Russia | Ukraine | KAR | KAR | MOS | Bad - Register |
| | | | | | | | | wrong GW |
| E | No | Ukraine | Ukraine | Poland | KAR | KAR | KAR | OK |
| F | No | Poland | Poland | Ukraine | KAR | AUS | AUS | OK |
| E | Yes | Any | Ukraine | Poland | KAR | NONE | KAR | Bad - User Rejected |
| F | Yes | Ukraine | Poland | Ukraine | KAR | KAR | AUS | Bad - Register |
| | | | | | | | | wrong GW |

The roaming problem is difficult in Europe due to the large number of gateways located in the region. FIG. 14 shows the relative locations of Ausaguel, Avenzano, Ogulbey, Moscow and Karkkila. Since these gateways are in such close proximity, when UTs are being registered the close proximity of the gateways increases the probability of error for roaming users using the last gateway registration method.

A third method of the present invention provides for map database enhanced registration, in which the service area map can be of help in resolving ambiguities.

Additions to the electronic map held in the memory of the gateway can resolve many ambiguity cases when they are presented. Basically, the concept adds to the Gateway Service Area Polygon regions outside of the service area similar to the solution for the Radio Astronomy Exclusion Zones. There are two kinds of these exterior zones. The first is a Restricted Zone, designed to reject calls or registrations if the ambiguous image (or real) position location is calculated. The second is a Non-Restricted Zone. This zone is designed to allow the UT probably located within the service area with an ambiguous image within the Non-Restricted Zone. This scheme could be called “conditional permissiveness” or a gateway using this could be called a “conditional permissive gateway”.

Case A: For some instances both ambiguity solutions will appear in the desired service area. The gateway can investigate both positions and if they are both within the service area, the gateway can accept the UT.

Case B: For some instances the ambiguity solution may fall outside of the desired service area but in an area that does not have an impact if the UT is granted access and the UT is actually at the location outside of the desired service area. An example of this is the service area of India. For example, refer to FIG. 14A, in which satellite 6 is moving down the west coast of India. A UT may be located at the position G. In a single satellite configuration, e.g., because there is only one satellite, or because the other satellite is blocked to the UT, an image occurs at position H. The database of a gateway (not shown in FIG. 14A) can be configured to have Restricted Areas outside of the India service area, and Non-Restricted Areas also out of the normal service area. For example, assume in the case of the Indian Ocean, there is no service provider and UTs can be accepted from outside the India service area, but inside the Non-Restricted Area because such acceptance would not cause an impact on the operation of the system, billing, or violation of border conditions. In this case the UT can be accepted. On the other hand, a UT at position I is located within the gateway service area and has an image at position J, which is in Pakistan. In this case the gateway, investigating the acceptability rejects the UT because the image falls within a Restricted Zone.

Case C: In some circumstances, a service area may be completely surrounded by a Restricted Zone. Nonetheless, this technique can reduce the zone of position failure due to ambiguous results. Consider FIG. 21A. The service area of the Ukraine is entirely surrounded by a Restricted Zone. When the center beam of satellite 12 is over the western portion of the service area the gateway can accept UTs for which the ambiguity lies totally within the service area and does not fall in the Restricted Zone. If a UT is truly in the Restricted Zone the position will fail as it should. If the UT is within the image of the Restricted Zone and within the service area (the zone of position failure) the UT will be deferred for a period of time. Notice that the center beam position failure in the service area is reduced by ½ for this example.

Case D: In some cases a service area may have both Restricted and Non-Restricted Zones. Consider FIG. 21B. A satellite 8 is passing over the juncture of a Restricted Zone and a Non-Restricted Zone. In this case the zone of position failure is reduced to a negligible amount for the center beam.

Case E: In some cases a large portion of the service area or even all of the service area may be surrounded by a Non-Restricted Zone. In this case as shown in FIG. 21C, all calls or registrations are accepted if ambiguity is found within the beam.

A fourth method in accordance with the present invention provides for use of both forward and return link beam information in the gateway calculation.

The gateway uses the POS_SAT_ID from the measured satellite, which is sent to the gateway by the UT in the Registration Message, to identify the beam within which the UT is located. This is the code division multiple access (CDMA) index code of the Satellite and Beam that the UT is receiving on the Sync Channel. The use of this index code allows the gateway to determine the beam that the UT is hearing the satellite on and therefore, combined with the frequency difference ,i.e., delta frequency, and the time difference ,i.e., delta time, calculate the position of the UT. For a single satellite case, the gateway, as discussed before, may calculate that there are two possible solutions. The index code of the UT received beam normally can resolve this ambiguity and declare the UT as either in or out of its service area. However, this method is not the best suitable in a case where both positions fall within the one gateway transmitted beam that the UT is reporting.

The gateway may further resolve the ambiguity. The gateway is receiving the UT on the same satellite that it is sending the Paging Channel to the UT. For this case, it is the only satellite available. It may be receiving a signal from the UT on one or more receive beams. In any case the gateway knows the beam identification number of the receive beam or beams. The receive beam pattern of the satellite is substantially different than the transmit beam pattern, and the receive beams are rotated with respect to the transmit beams.

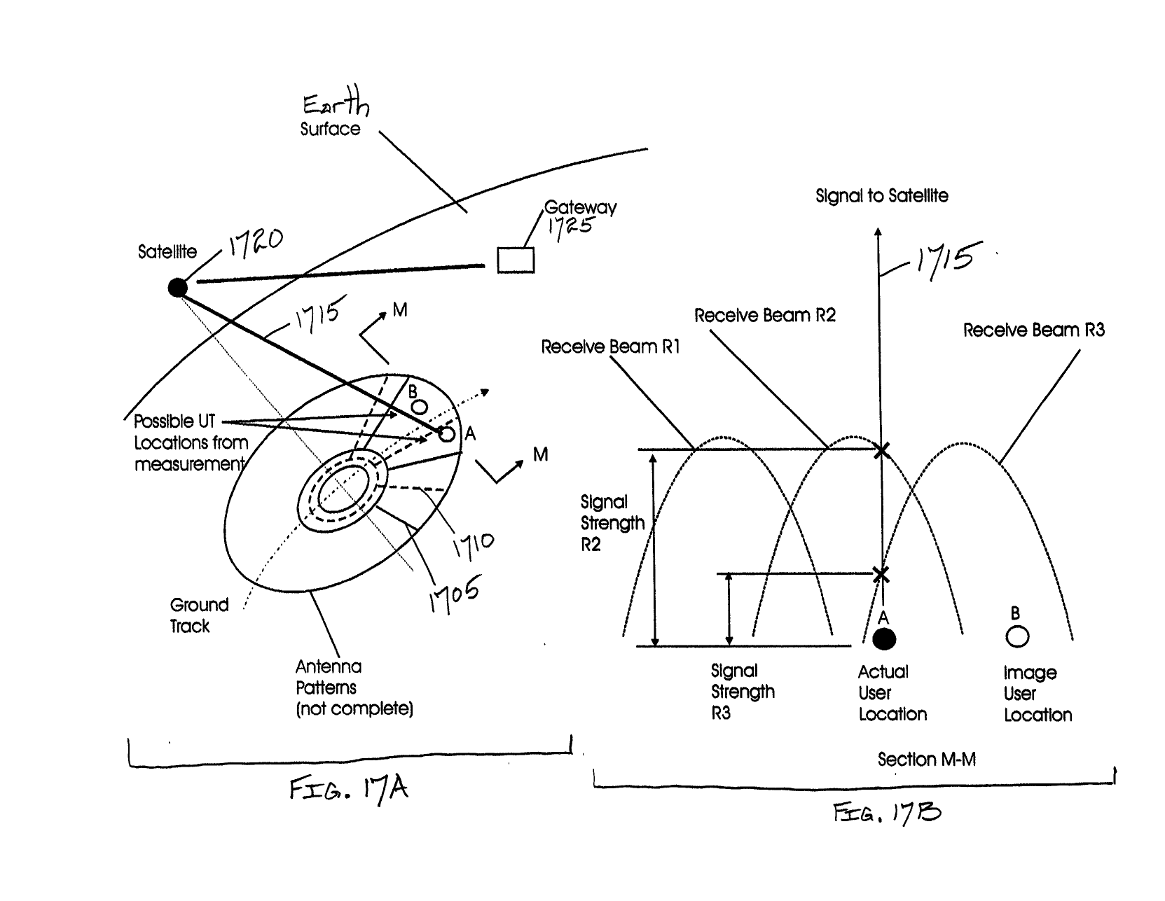

FIG. 15 shows a satellite transmit beam pattern and a receive beam pattern overlaying one another. The solid lines are the transmit beam boundaries and the dashed lines are the receive beam boundaries. In general, the middle and outer transmit beams (the largest area on the ground) are split by the outer receive beams. This non-congruence of the beams can be used to further resolve ambiguities.

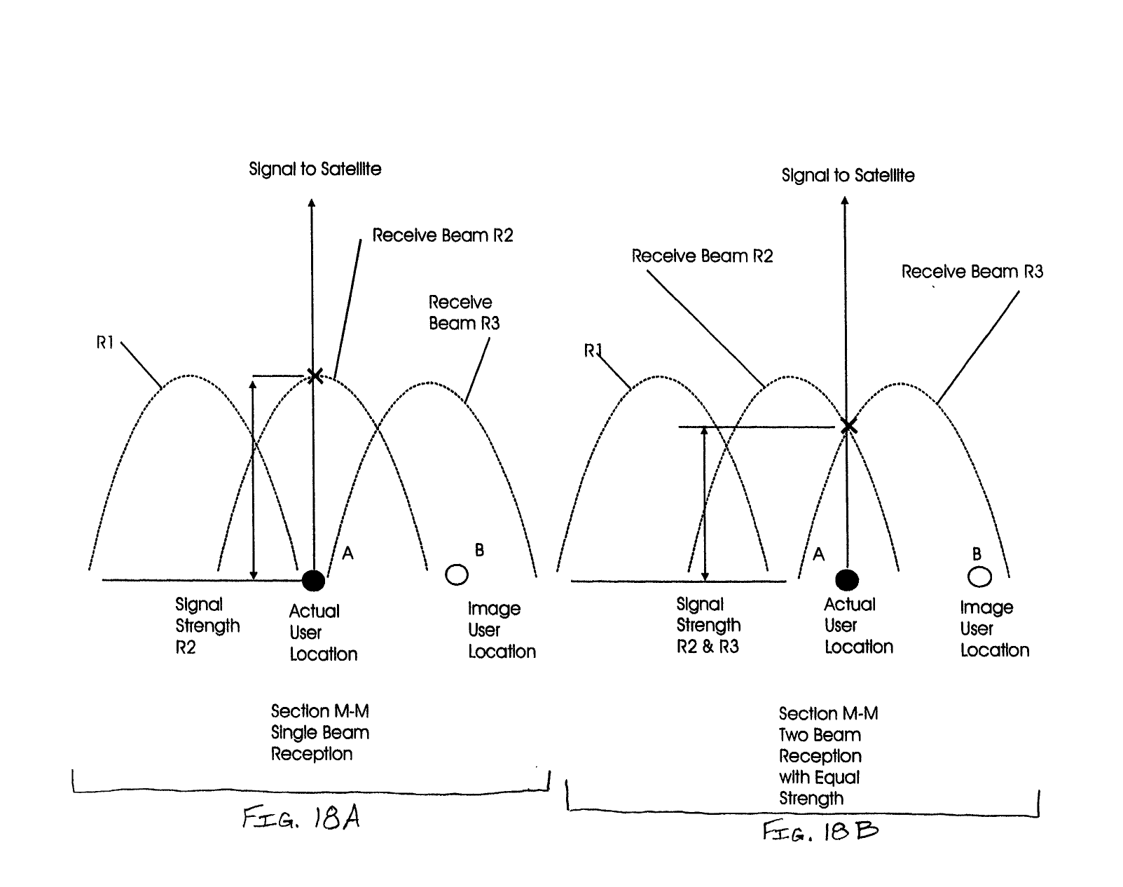

FIG. 16 shows a UT at A located in an outer satellite transmit beam T2. The gateway calculates an image at B, which is outside of the Ukraine service area. Using the method of registering if the stored value of the last service provider ID is able to be served by the gateway, as described earlier, if the UT was last registered in the Ukraine, then the gateway assumes that the UT is presently located in the Ukraine. If the UT data is corrupted or non-existent, or the UT has roamed to the Ukraine, then the UT would be rejected. However, the use of both forward and return link beam information in the gateway calculation would prevent that occurrence.

In this example, the satellite S-band transmit beam T2 is split by the satellite L-band receive beams R2 and R3. The gateway can thus determine if the UT is at A or B by investigation of the beam of reception.

It may be that the gateway is receiving the UT on more than one beam simultaneously, since the UT is broadcasting its signal. The gateway can determine the rough position of the UT by considering the signal strength of the receive signals.

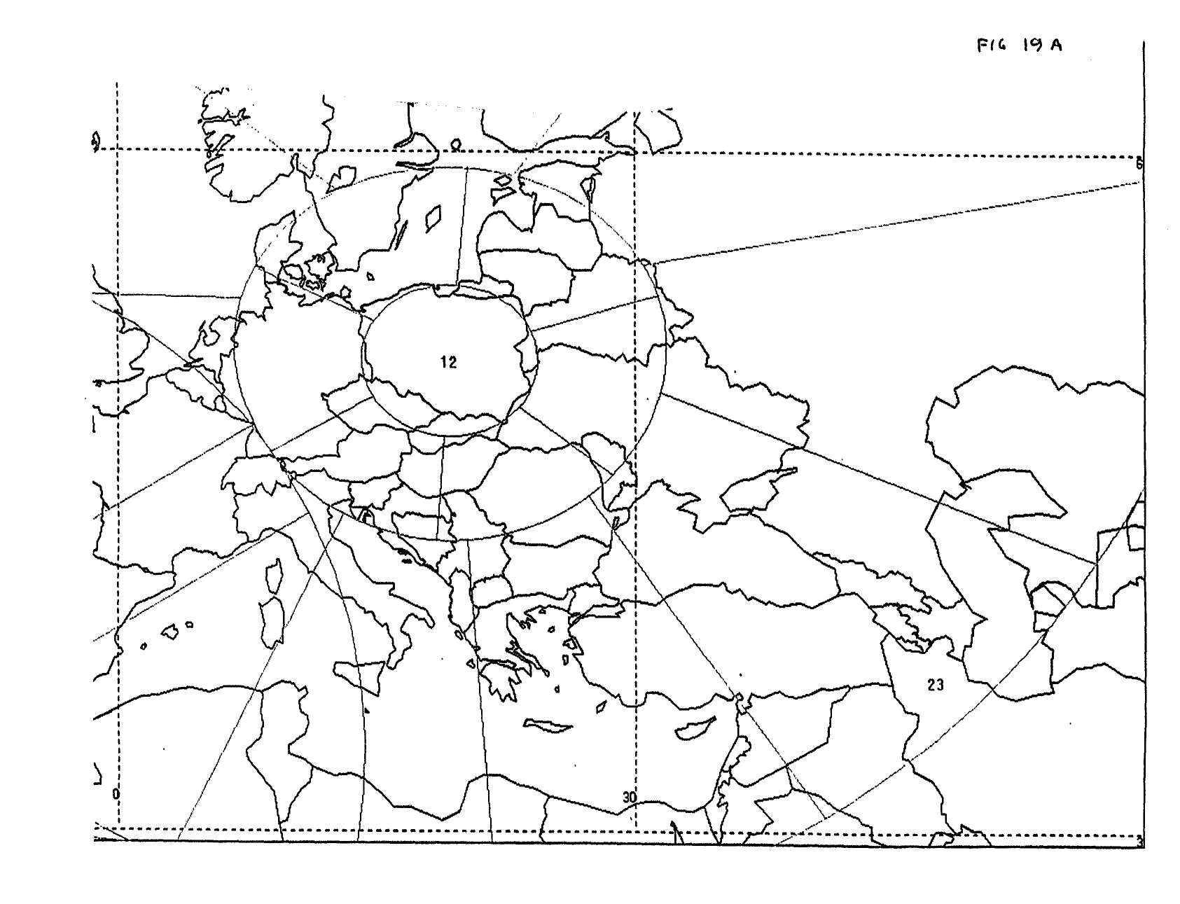

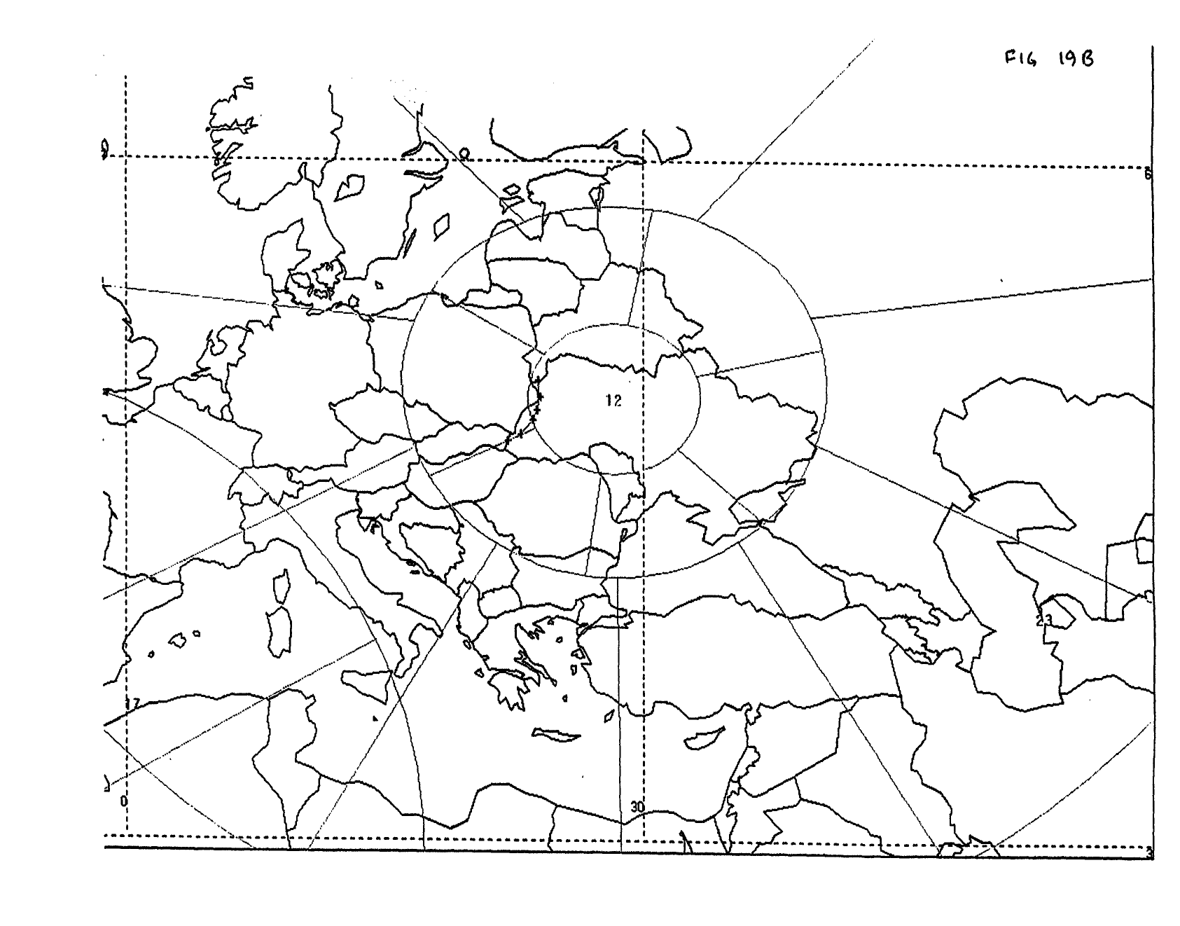

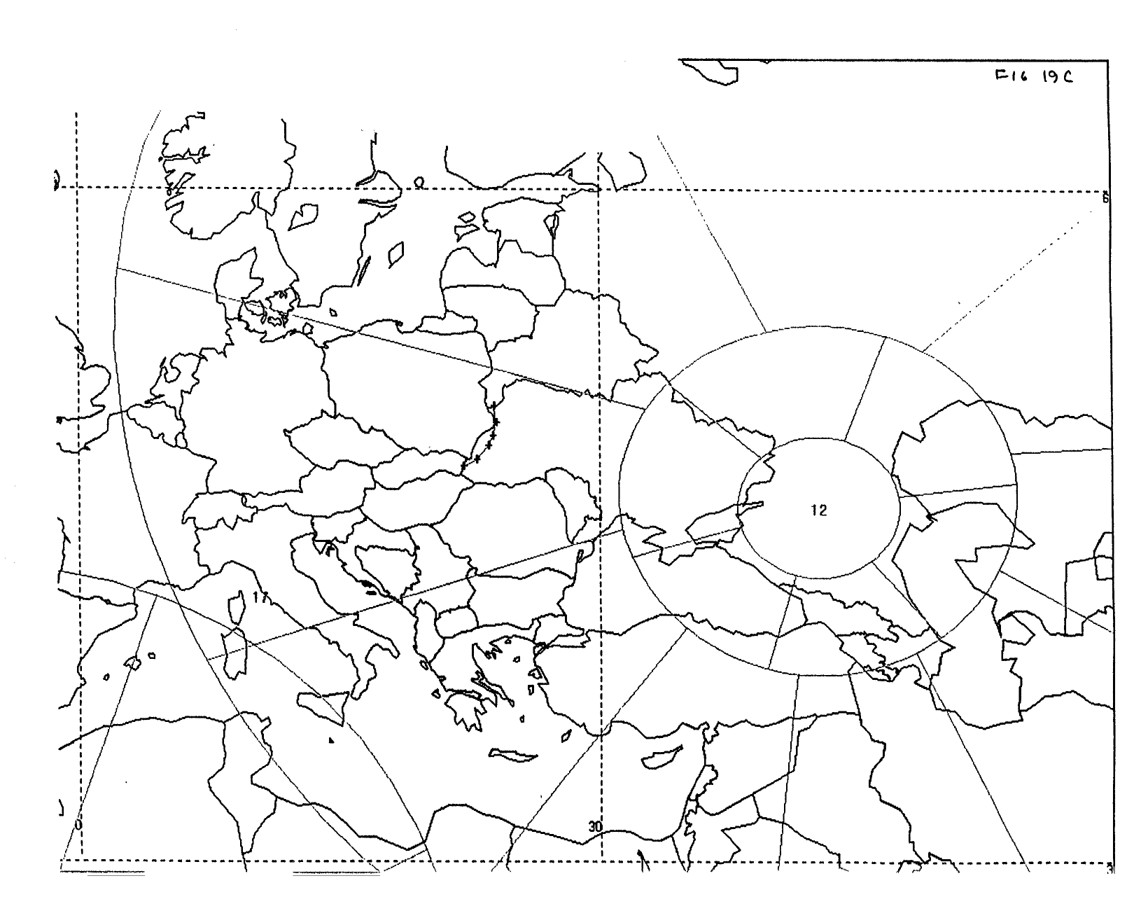

Consider FIG. 17A. For the case shown in FIG. 16, the gateway can determine that the UT is indeed at A in the Ukraine and not at the image position B. In FIG. 17A, a satellite beam pattern is moving along the ground track and has a forward link beam in a position to give an ambiguous position location for a UT located at A. Both the transmit antenna pattern 1705 (solid lines) and the receive antenna pattern 1710 (dashed lines) are shown in the perspective.

FIG. 17B is an antenna pattern of a beam received at section M-M of FIG. 17A. FIG. 17B depicts the relative antenna patterns at section M-M at the surface of the earth. The transmit pattern is not shown. A signal 1715 to the satellite 1720 is shown emanating from the actual UT location at A. Signal 1715 will be received by satellite 1720 and relayed to the gateway 1725. If the UT is received in only one receive beam, then gateway 1725 can resolve the ambiguity. Gateway 1725 has knowledge of the orientation of the satellite and the beams with respect to the ground. Therefore, the beam boundaries of the reception beam are known at each instant in time, or at least as frequently as every one or two seconds. Since these factors are known, gateway 1725 can determine the UT's location at A uniquely from that of the image position at B.

There is a possibility that the UT will be near a receive beam boundary where the signal from the UT will be of sufficient strength in two beams to be used by the gateway. In this case, without further information gateway 1725 would only know that both A and B are possible locations. As shown in the example of FIG. 17B, the UT will be received by gateway 1725 on receive beam R2 and R3, but R1 is too far from the UT to have enough signal strength to be used. Gateway 1725 can further resolve the ambiguity by using the signal strength of beam R2 and R3. Since the strength of one will be in general higher than the other it can be determined that A is the actual location, since the signal strength of beam R3 would have to be higher than that of R2 in order for the UT to be at location B.

There are two other cases, one being that the gateway is receiving the UT only on one beam, and the other being that the gateway is receiving the UT at the same signal strength on two beams.

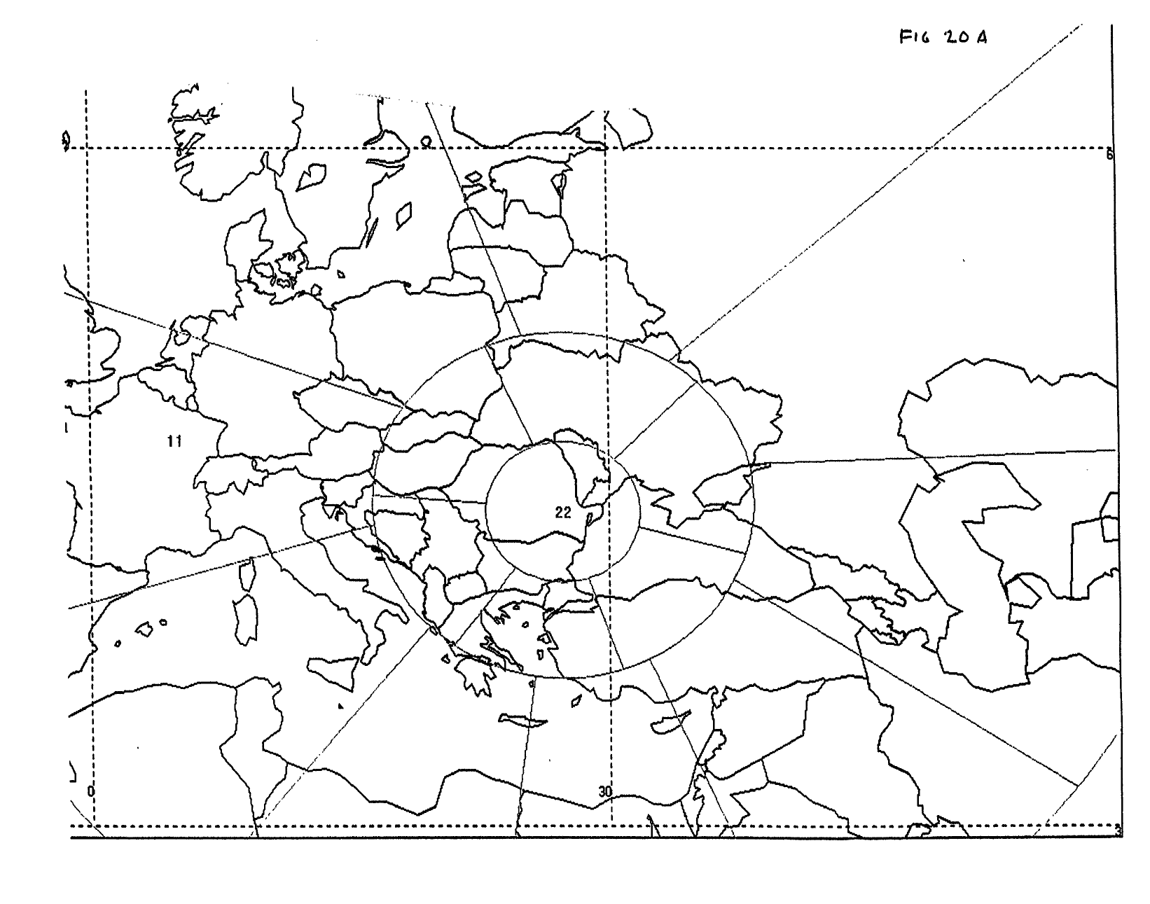

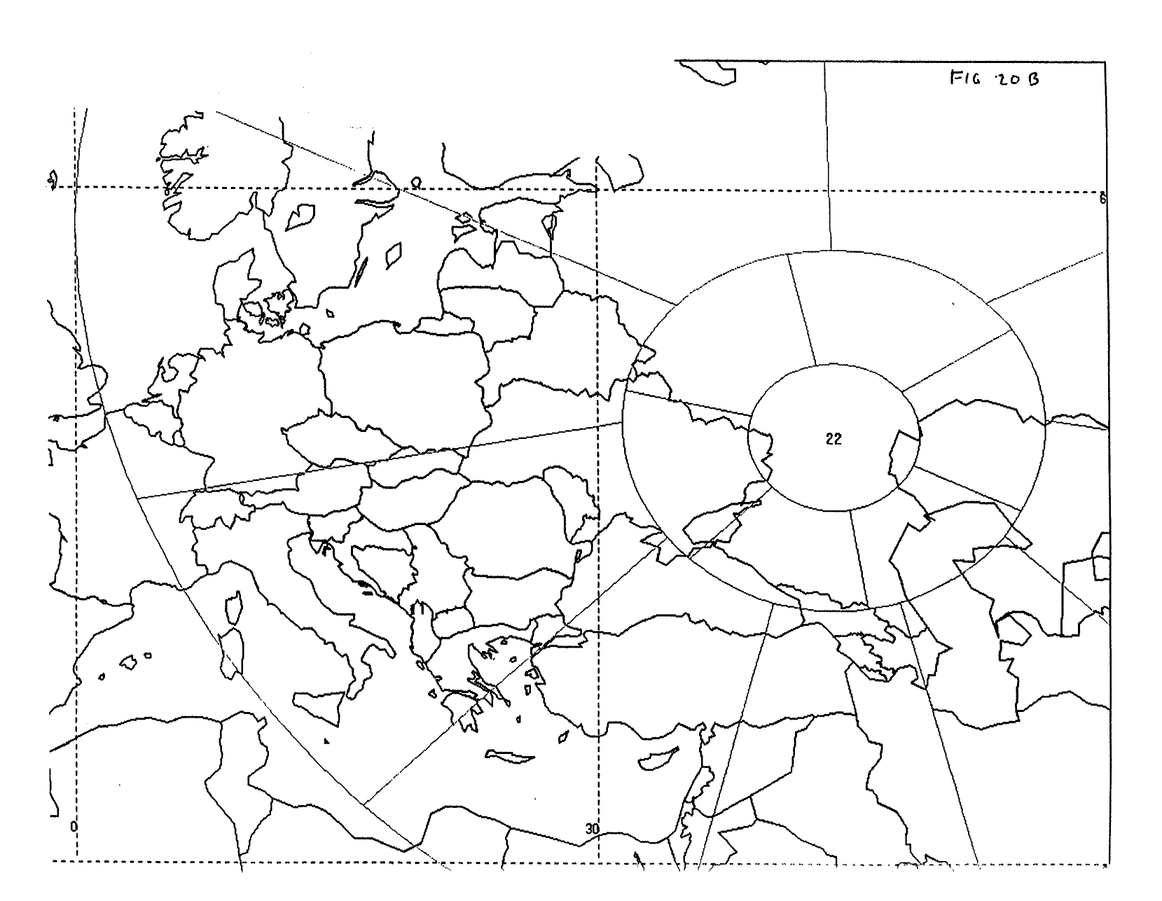

FIG. 18A shows the receive beams for the case where the gateway is receiving the UT only on one beam. As described above the gateway can resolve the ambiguity by the use of the known position of the satellite and the antenna pattern alone, in this case the signal strength is not needed.

FIG. 18B shows the receive beams for the case where the gateway is receiving the UT at the same signal strength on two beams. In this example, the gateway receives two equal strength signals from both beams R2 and R3. If the two signals are equal, the beam pattern is again used to resolve the ambiguity. Reception on beams R2 and R3 leads to a conclusion that the UT lies along a line between the boundary of these two beams. Using the beam pattern orientation stored in the memory of the gateway, which is updated periodically by the SOCC, and using simple geometry, the ambiguity is resolved.

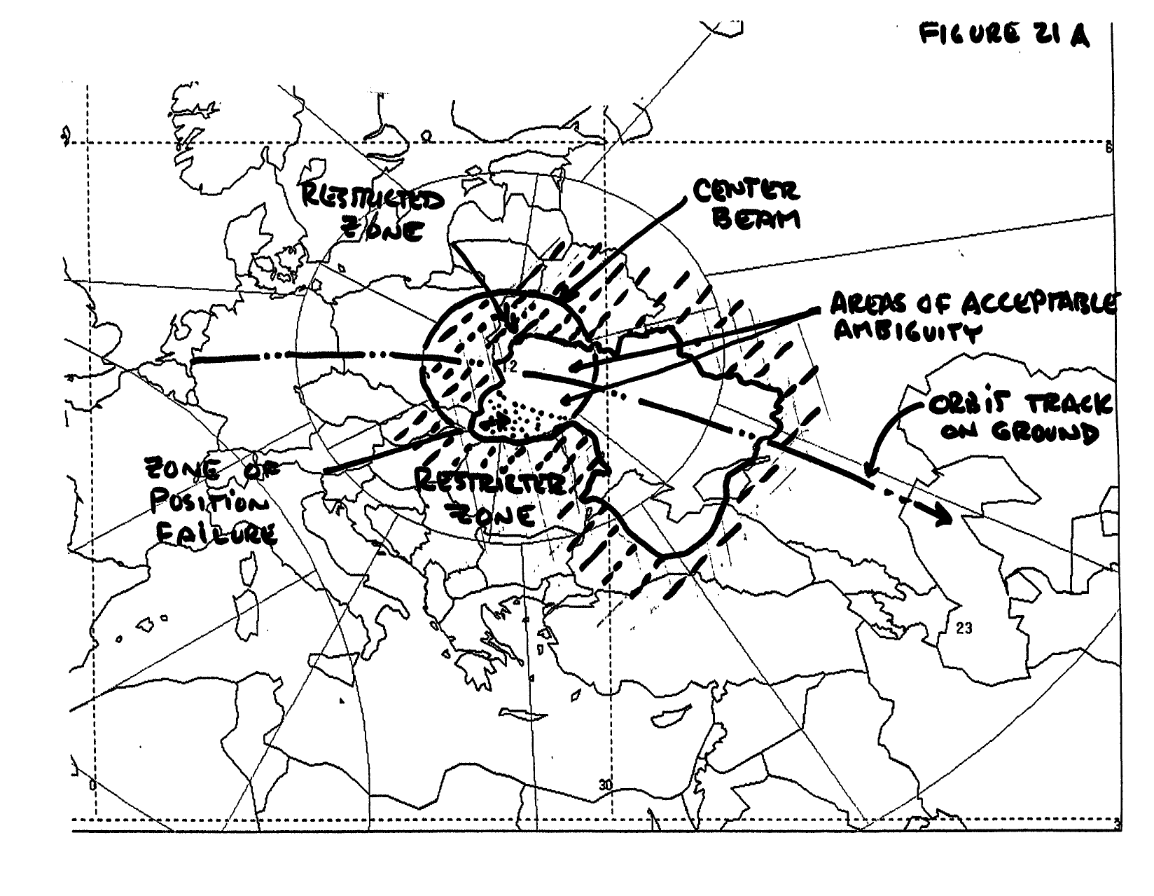

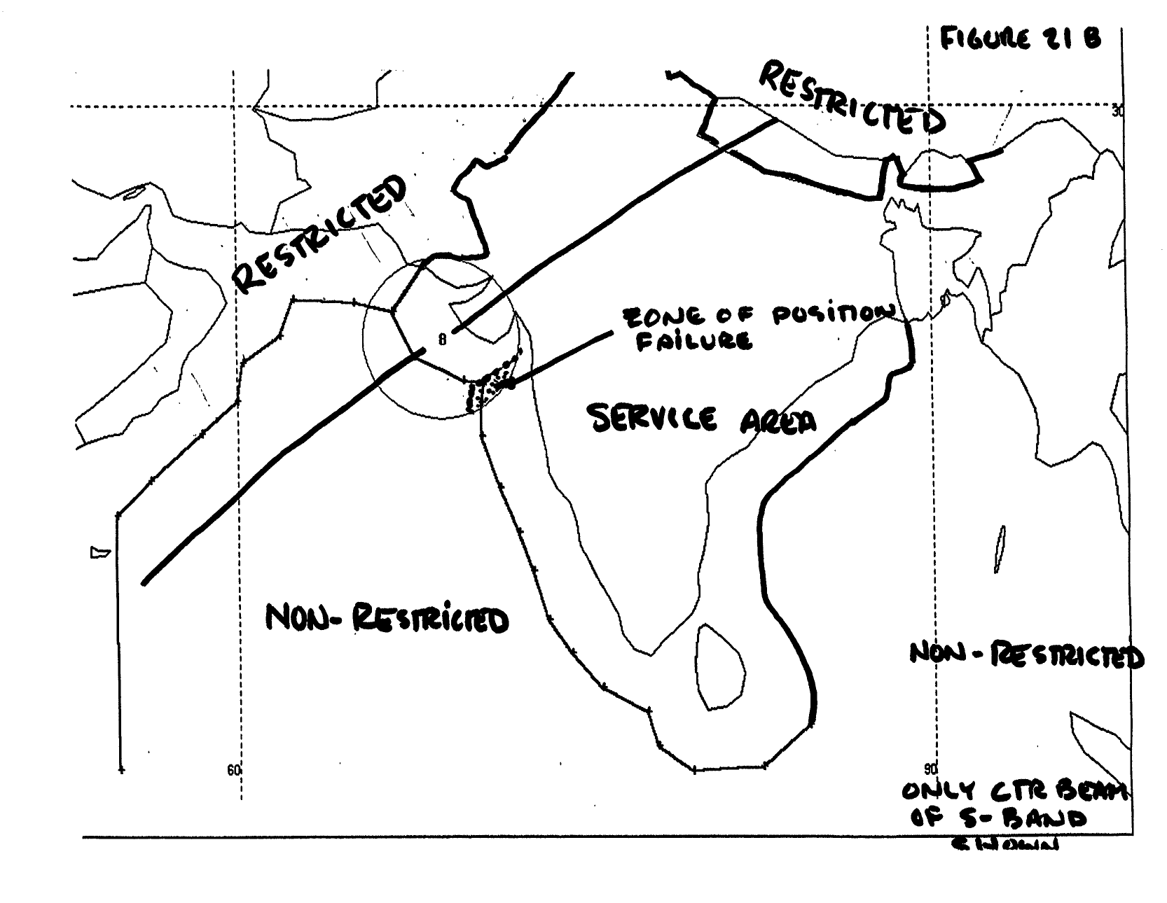

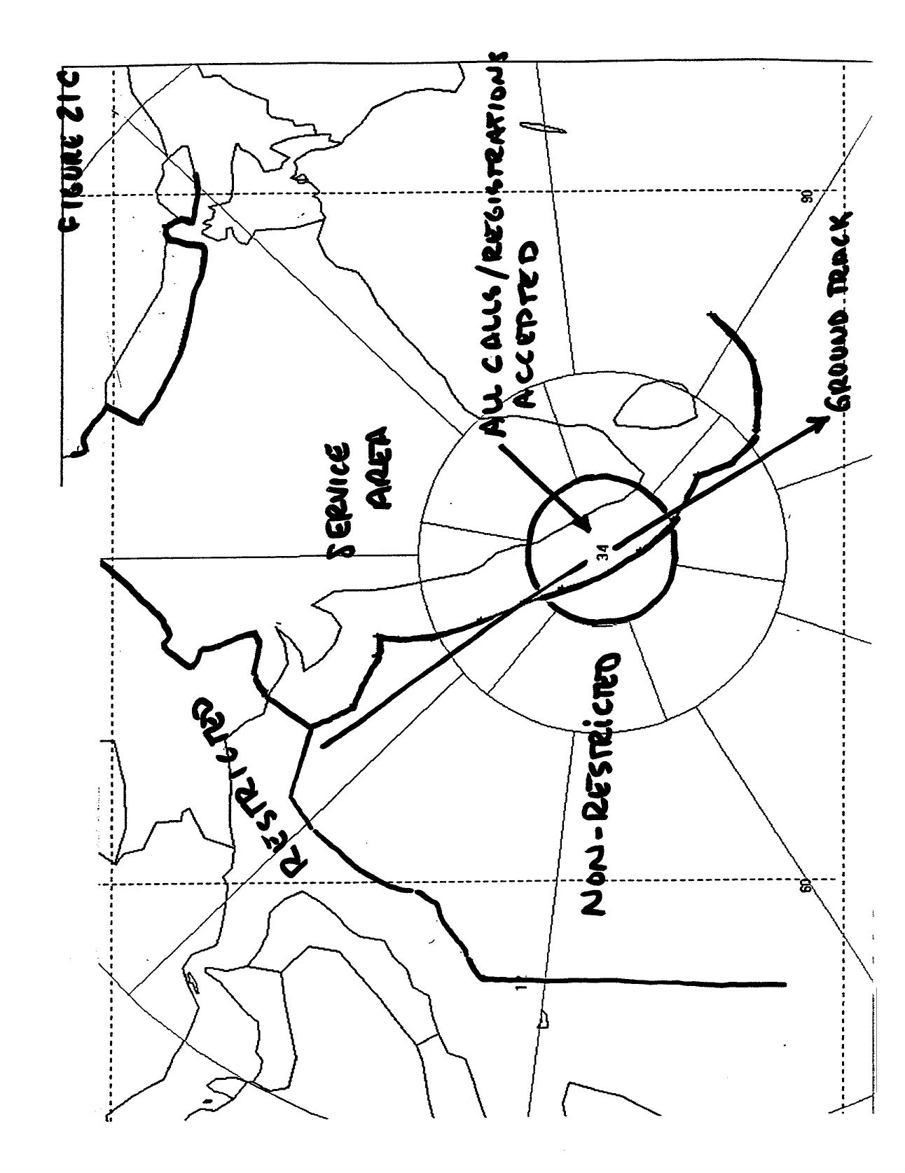

Ambiguity will still be found when the central beam is being used for the position measurement by the UT. The central beam of the transmit satellite antenna and the central beam of the receive satellite antenna coincide. The use of the stored value of the last registered UT will help resolve the ambiguity for all but those UTs that are roaming. This condition is transient in nature. Take for example, the condition shown in FIGS. 19A-19C for a pass the length of the Ukraine, and FIGS. 20A and 20B for a pass across the Ukraine. Table 6 shows the length of time that the center beam situation will occur, and the length of time for a particular UT to be able to attempt another call or registration.

TABLE 6

| | | | Delta | |
|---|---|---|---|---|
| | | | Time | |
| | | | From | |
| Sat | FIG. | Time | Start | Condition |
| 12 | 19A | 01:37:20 | 0 | Onset of central beam |
| | | | | ambiguity in Ukraine |
| | 19B | 01:39:16 | About 2 | First users with |
| | | | minutes | ambiguity now can be |
| | | | | resolved |
| | 19C | 01:42:35 | About 5 | Last of ambiguity in |
| | | | minutes | Ukraine |
| 22 | 20A | 03:54:40 | 0 | Onset of central beam |
| | | | | ambiguity in Ukraine |
| | 20B | 03:58:38 | About 4 | Last of ambiguity in |
| | | | minutes | Ukraine |

The maximum duration of center beam ambiguity measurements in the Ukraine is about 5 minutes and the duration for any particular UT is about 2 minutes. To prevent the UT from trying the gateway too often during a central beam pass the deferment timer may be set to 2 minutes. During this time the UT can attempt to register on another gateway, but since the UT is truly in the Ukraine these registrations should fail. Nonetheless, it will prevent the UT from attempting registration every 20 seconds for a minute, thus gaining immunity from the “4 tries and your out” timer.

The technique of map based enhanced registration discussed earlier can be used with this method. Together they can reduce the rejected calls and deferred registrations to a negligible number. Since the use of both the forward and the return links for reduction of ambiguous position failures will remove the bulk of the failures, the map-based enhancement will further reduce the failures due to other causes such as center beam failures.

For example, consider FIG. 21A. The Ukraine service area would be surrounded by a Restricted Zone according to the method of map based enhanced registration. Therefore, only calls or registrations from within the Ukraine are acceptable. Using both the forward and the return links the only remaining ambiguities are found within the center beam. Using the map based enhanced registration about half of those can be resolved. The gateway can accept all those UTs that have ambiguity positions that fall entirely within the Ukraine service area. In this example, the remaining UTs attempting to register or obtain radio resources would have ambiguity falling within the Restricted Zone and be rejected.

A fifth method in accordance with the present invention directs the UT to obtain additional position measurement data from the pilot of another satellite with the pilot being sent from a different gateway.

The gateway messages sent to the UT during the log on process may be used to send a message to the UT to temporarily acquire a different satellite and gateway to obtain more measurements and its location. Once its location is found it may be transmitted to the original gateway for processing. In order to perform this process the gateway computing system considers the location of the UT from both ambiguity positions. Armed with this information it may make an intelligent guess as to which gateway to direct the UT to obtain its un-ambiguous position. It then forms a Service Redirection Message to send to the UT. The contents of the Service Redirection message is shown in Table 7.

TABLE 7

| | | |
|---|---|---|
| AMBIGUITY | Ambiguity flag | Set to Originating |
| | | GW number |
| | One or more of | |
| | the following | |
| RECORD_TYPE | Redirect Record type | Redirection Criteria |
| | | 00000000 = another GW |
| | | 00000001 = AMPS/CDMA |
| | | 00000010 = CDMA |
| | | 00000011 = GSM |
| | | 00000100 = DCS-1800 |
| | | 00000101 = PCS-1900 |
| | | Other values reserved |
| RECORD_LEN | Record Length | Set to length of type |
| | | specific fields |
| EXPECTED_GW | Expected Gateway | Gateway identifier of the |
| | | one the UT is directed to |
| NUM_CHANS | Number of | Set to number of |
| | CDMA_CHAN | CDMA_CHAN |
| | entries | fields for the new GW |
| | | channels to acquire |
| | One or more of | |
| | following for each | |
| | Expected GW | |
| SAT_ID | Satellite Identifier | Set to Expected GW |
| | | sats used |
| CDMA_CHAN | CDMA ch number | Set to CDMA ch in use |
| | | by Expected GW |

The Gateway sets the ACK_REQ to 1 to have the UT acknowledge that it received the Service Redirect Message. It sets RETURN_IF_FAIL flay to 1 in order to have the UT return to itself if the registration on the other gateway is not successful. It sets AMBIGUITY to its Gateway Number, to allow the receiving gateway to redirect the UT back to the originating gateway. It sets RECORD_TYPE to 00000000, which means another Gateway, sets EXPECTED_GW to the predetermined Gateway number to try, and sets NUM_CHANS to the number of CDMA GATEWAY channels to try and acquire. More than one gateway may be selected to be used. In this case multiple records are generated. For each expected gateway, a SAT_ID (satellite identifier to be used) and the CDMA channel number in use by the expected gateway (CDMA_CHAN).

The UT receives this message and is directed to try to register with a different gateway. It then searches the CDMA_CHAN selection channel number and tries to acquire the expected gateway.

If successful, then the ambiguity was in the new service territory and the UT begins normal communications with the expected gateway.

If unsuccessful, the UT sends a message to the expected gateway requesting its position location to be sent to the UT. To perform this function the UT forms a Position Request Message with the information shown in Table 8.

TABLE 8

| | | |
|---|---|---|
| REF_SAT_ID | Reference Satellite ID | Set to Identifier of the |
| | | time ref satellite |
| REF_BEAM_ID | Beam assoc with pilot | Set to ID of beam assoc |
| | | with pilot as ref for |
| | | demod fwd ch |
| TX_DELAY | Transmit Delay | The unsigned time difference, |
| | | measured at the antenna, |
| | | between the long code states |
| | | of the UT transmitter and |
| | | the UT receiver monitoring |
| | | the satellite transmitting |
| | | the reference beam. |
| REQUEST_{—} | Type of Request | Set = 0 for range |
| TYPE | | information only. |
| NUM_POS | Number of Records | Sets following number of |
| | | records |
| | One or more of the | |
| | following | |
| POS_SAT_PN | Satellite PN Spreading | Set to value of the spreading |
| | code index | code index of the satellite |
| | | measured |
| DT_INCL | Include Delta T flag | Set to 0 for ref. Sat, else |
| | | set = 1 |
| DT | Delta Time fm ref sat | Set to measured value |
| DF | Delta frequency | Set to measured value |
| POS_AGE_{—} | Include record flag | Set to 0 if measured time is |
| INCL | | same |
| POS_AGE | System Time | Set to system time |
| | Message ends with | |
| | following fields | |
| RTN_TO_{—} | Return to originating | Set to 1 to tell Expected GW |
| ORIG_GW | gateway | if position is successful to |
| | | send a Service Redirection |
| | | Message back to UT after |
| | | sending the Position Data |
| | | Message |

The Expected Gateway then attempts to position locate the UT. If successful, the position data is transferred to the UT with a Registration Response Message. The Registration Response will be negative since the Expected Gateway is not the desired one for the UT. The Gateway can transfer the actual location of the UT in terms of latitude and longitude and even the estimated position location error. However, the calculated data for the range between the satellite and the UT could also be used. The Gateway forms the Registration Response Message, which contains the information shown in Table 9.

TABLE 9

| | | |
|---|---|---|
| ADDRESS | UT Address | This identifies msg to |
| | | the user |
| REG_RESULT | Registration Result | Values in field tell user results |
| SP_MASK | Service Provider Mask | If result = 001 or 010 set this |
| | | number to allow UT to select |
| | | another SP on this GW |
| SP_INDEX | Service Provider Index | If result is 000 (registered) |
| POS_INCL | Position include flag | If the GW calc pos set = 01 |
| POS_TIME | Time of pos location | Set if POS_INCL = 01 |
| UT_LAT | UT latitude | Set if POS_INCL = 01 |
| UT_LON | UT longitude | Set if POS_INCL = 01 |
| UT_ALT | UT altitude | Set if POS_INCL = 01 |
| POS_ERROR | Position Error value | Set if POS_INCL = 01 |
| DIGIT_TMODE | Dial Digits mode | Set if = result = 000 |
| | | (accepted) |

The Address Types include:

000=IMEI

001=ESN

010=IMSI

011=TMSI

101=BROADCAST

The Registration Results are the qualification information:

000=Registration accepted

001=Registration rejected by Network

010=Registration rejected by Network, delete TMSI

011=Reserved but may be used for Ambiguous Position location

100=Registration rejected by Network, no other SP available

For the Service Provider Mask, if the result is a rejection by the network, delete TMSI fill in field with the list of gateway service providers supported and listed in the Gateway Service Provider List which has been received by the UT.

For the Service Provider Index, if registered then the gateway sets this to the rank number of the gateway SP selected from the list of SPs in the Gateway Service Provider List previously sent.

For the position include flag, set only if the gateway is not restricted from providing. If it is restricted set, then set:

10 if restricted and omit position information

00 if not restricted and no result

The position error value is a measure of the quality of the calculation, not an absolute value, corresponding to:

000=<10 km

001=Position Failed

010=<300 m

011=<1 km

100=<2 km

101=<5 km

110=<20 km

111=<100 km

For the dial digits mode, 0 allows the UT to put dialed digits into Origination Message or in the Origination Continuation Msg.

Alternatively the fields UT_LAT, UT_LON, UT_ALT and POS_ERROR may be omitted and one or more fields of range information and the satellites pertaining to them may be substituted. For example, one or more of the types of information shown in Table 10 may be sent.

TABLE 10

| | | |
|---|---|---|
| RANGE_INCL | Range include flag | If the GW sends range |
| | | set = 1 |
| SAT_ID | ID of sat that RANGE is | Set if directed to |
| | associated with | |
| RANGE | Range between Satellite and | Set if directed to |
| | User | |

The message type is set to that of Registration Response, and the ACK, Sequence, and Address fields are sent to that of the UT. REG_RESULT will be set to 011 indicating ambiguous position location information being sent back to the UT. Then either the actual position value fields are filled in or the range information is filled in. The gateway then sends the Registration Response Message to the UT. The UT then either forms a Position Data Message to send to the gateway or alternatively may re-send the Registration Message, this time filling in the fields for POS_INCL=1, UT_LAT, UT_LON, which have been calculated by the expected gateway and sent to the UT. Optionally POS_ERROR may be sent. If the RANGE information is used these values are sent to the gateway. Alternatively the UT_LAT, UT_LON data may be sent in a Position Data Message. Likewise the RANGE information may be sent in a Position Data Message. In any case the gateway receives the position location data from the UT and uses it to resolve the ambiguity.

If the expected gateway cannot perform the necessary calculations, it may supply range information for at least one satellite. Other expected gateways may be selected, as described above, therefore a combination of information may be gathered from various gateways and supplied via the UT to the originating gateway.

A sixth method in accordance with the present invention directs the UT to obtain additional position measurement data from satellites that are visible to itself but not to the gateway.

The UT in general “sees” or has a direct line of sight to more satellites than the gateway can “see” or to which it has a direct line of sight. This is especially true for satellites that are at a long distance from the gateway. These satellites may be transmitting pilots from other gateways as discussed earlier in the fifth method, i.e., directing the UT to obtain additional position measurement data from the pilot of another satellite with the pilot being sent from a different gateway. The gateway, without performing the calculation described in the fifth method, and without directing the UT to attempt registration on an “expected gateway”, can direct the UT to seek out these other pilots and make range measurements, then report them back to the gateway for further processing and resolution of the ambiguity. If the UT does not “see” any additional satellites, then the ambiguity will continue to exist and other methods of this invention will be used to resolve the ambiguity.

The process for directing the UT to make these additional measurements is as follows. The gateway forms and sends to the UT a Neighbor Gateway Configuration Message. The message contains the information shown in Table 11.

TABLE 11

| | | | |
|---|---|---|---|
| | | One or More | |
| | | of the | |
| | | following | |
| OTHER_GW_ID | Gateway | | Set to one or more |
| | Identifier | | neighboring gateway ID |
| NUM_FREQ | Number of freq | | The number of CDMA |
| | used | | channels with paging |
| | | For each GW | |
| | | one or more | |
| | | of | |
| CDMA_CH_NUM | Channel number | | The ch number of page ch |
| PILOT_CCHAN | Pilot Channel | | which Code Channel in |
| | Code | | use |
| SEARCH_PILOT | Direction to UT | | Set to 1 to activate UT |
| | for search for | | to search for neighbor |
| | pilots | | GW pilots |
| RETURN_MEASURE | Direction to UT | | Set to 1 to direct UT to |
| | to return | | return measured range |
| | measured data | | data from neighbor |
| | | | gateway |

The gateway fills in the fields with the data pertaining to its neighboring gateways, in particular the frequencies and CDMA channel information to allow the UT to find and seek out the pilots, and sends the message. The UT is directed to seek out the pilot(s) from one or more neighboring gateways and return this data to the gateway. In turn the UT, upon receiving this message seeks out the pilot(s) from the neighboring gateway, performs a range measurement obtaining one or more of the set of data shown in Table 12.

TABLE 12

| | | | |
|---|---|---|---|
| | | Position | |
| | | location | |
| | | fields | |
| NUM_POS | Number of records | | The number of |
| | | | measurements |
| | | For each SAT | |
| | | included | |
| POS_SAT_PN | Sat PN spreading | | The code for this record |
| | code | | |
| DT_INCL | Delta time incl. | | 0 for ref sat, 1 for all |
| | flag | | others |
| DT | Delta Time | | Signed time difference |
| DF | Delta Frequency | | Signed carrier delta freq |
| POS_AGE_INCL | Pos Age include | | If age same as prey |
| | flag | | record set = 0 |
| POS_AGE | Postion Data Age | | Increments of 1.25 ms |

DT is defined as the relative arrival time Ta of at least one Pilot Ch for each satellite, which is the time between the start of a cycle of the outer PN sequence of the Pilot with the monitored Paging Channel and the next time at which the start of a cycle of the outer PN sequence of the other satellite. This value is measured to a precision of ⅛^{th} of a chip. After obtaining the value of Ta the value of DT may be calculated using common techniques.

The DF is defined as the frequency of the Pilot of the measured satellite minus the nominal carrier frequency of the Pilot channel as derived from the UT local oscillator. DF is calculated by the UT using common techniques.

The UT then forms a Position Data Message with a current measurement, if necessary, from the original gateway and the data from the measurement of the pilots sent from the neighboring gateway through satellites not used by the original gateway. The Gateway upon receiving the additional information then proceeds to resolve the ambiguity with the additional range data provided.

A seventh method in accordance with the present invention sends satellite ephemeris information to the UT for it to calculate its position based on both of the ambiguous positions after measuring the range to the new satellites, then reports position to the gateway.

The UT can aid directly in resolving the ambiguity by participating in the calculation process. The gateway can send the neighbor gateway information with the other satellite ephemeris data for satellites, used by the gateway and not being used by the gateway, held in memory of the original gateway. The UT then uses the method of directing the UT to obtain additional position measurement data from satellites that are visible to itself but not to the gateway, as discussed earlier, to acquire range information from the satellites not in view of the original gateway. The UT then uses the satellite ephemeris, sent to the UT by the original gateway, and the delta times and delta frequencies measured by the UT to calculate its actual location. It then forms a Position Location Message containing the latitude and longitude of the UT or alternatively the range information and sends it to the gateway for resolution of the ambiguity.

An eighth method in accordance with the present invention uses the pilot from a third satellite that is visible to the UT, but not necessarily to the gateway. This method uses Doppler only from the pilot and other overhead channel to define additional contours of position that may resolve the position ambiguity. Note that this does not require the support of other gateways.

A ninth method in accordance with the present invention uses another gateway to measure and report the range and Doppler and calculated position, including ambiguous locations, of a UT that attempts to register after being deferred to another gateway. This could be done by having the UT report this information to each gateway with which it tries to register, providing that the measurement was done “recently”. If the UT returns to the original gateway, where it is in the gateway service area, then sufficient time may have elapsed to allow the original measurements, measurements from any other gateways that the UT tried to register on, and the current measurement, to successfully resolve the PL ambiguity.

A tenth method in accordance with the present invention provides for having the gateway store the position of UTs, and if a successful measurement was done “recently” use that measurement or a region, which may be time variable and based on the time of last successful measurement, to resolve the ambiguity. For example, if one, and only one, of the newly measured positions is within a predetermined, possibly time variable, distance from the last successful position, that position is used.

The following discussion proposes the criteria by which a selection of one or more of the methods described herein can be made. Although some gateways may not need to employ any of these methods, other gateways will benefit by employing one or more of the methods. In some cases, the methods described herein can be combined to eliminate most or all of the ambiguity rejections. The criteria, in order of most important first:

(a) Does the solution require a change to the UT software.

(b) How well does the solution prevent “wrong gateway” assignments.

(c) Protection of roamers.

(d) What is the solution's potential to eliminate ambiguous rejections.

(e) Ease of implementation.

(f) Cost.

(g) Can the solution be combined with other solutions.

The methods described above may be combined to gain advantages of both. Table 13 shows the merits of combining methods.

TABLE 13

| | | | Prevention | | |
|---|---|---|---|---|---|
| | | | of | | |
| | UT | Fixes | Wrong | Prevention | Elimination |
| | Chg | What | Gateway | of Roamer | Of |
| Method | Reqd? | Beams | Assignments | Rejection | Ambiguities |
| Last Reg + | NO | ALL | Good | Poor | Fair |
| Map | | | | | |
| Last Reg + | NO | NOT | Very Good | Good ++ | Excellent |
| Fwd & Rtn | | Center | (Except Ctr | (Excpt Ctr | (Excpt Ctr) |
| Beam | | | Beam) | Beam) | |
| Last Reg + | NO | ALL | Excellent | Excellent | Excellent |
| Fwd & Rtn | | | | | |
| Beam + | | | | | |
| Map | | | | | |
| Enhanced | | | | | |

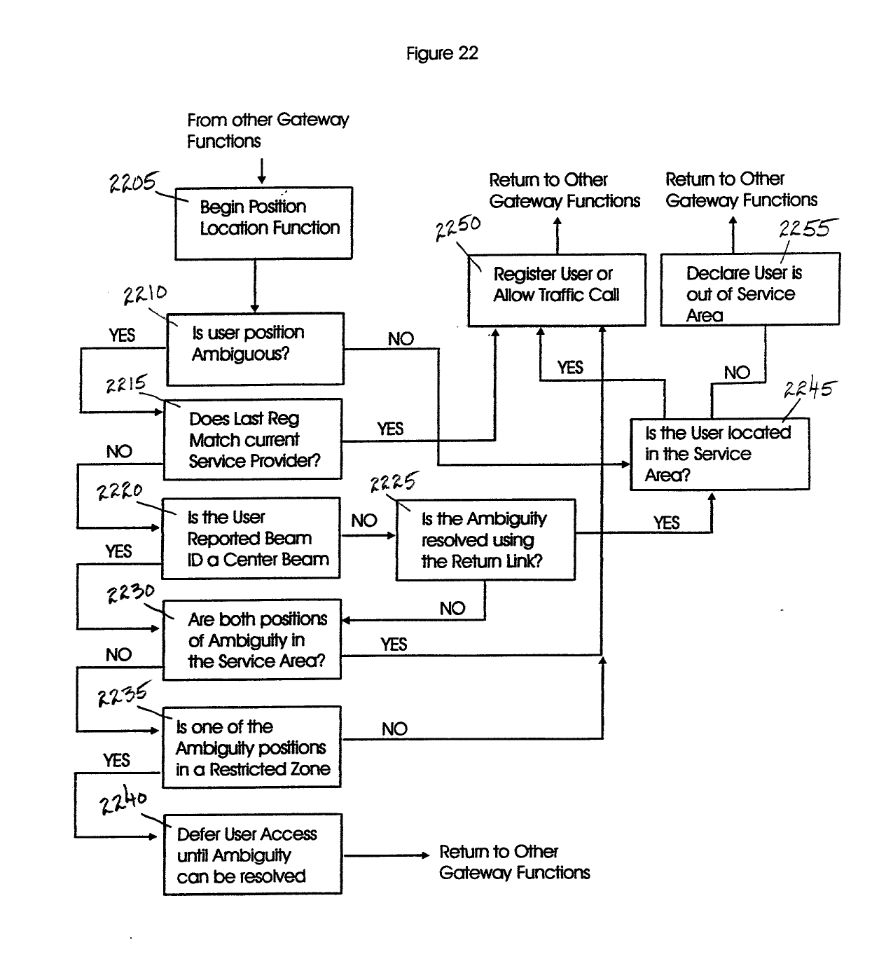

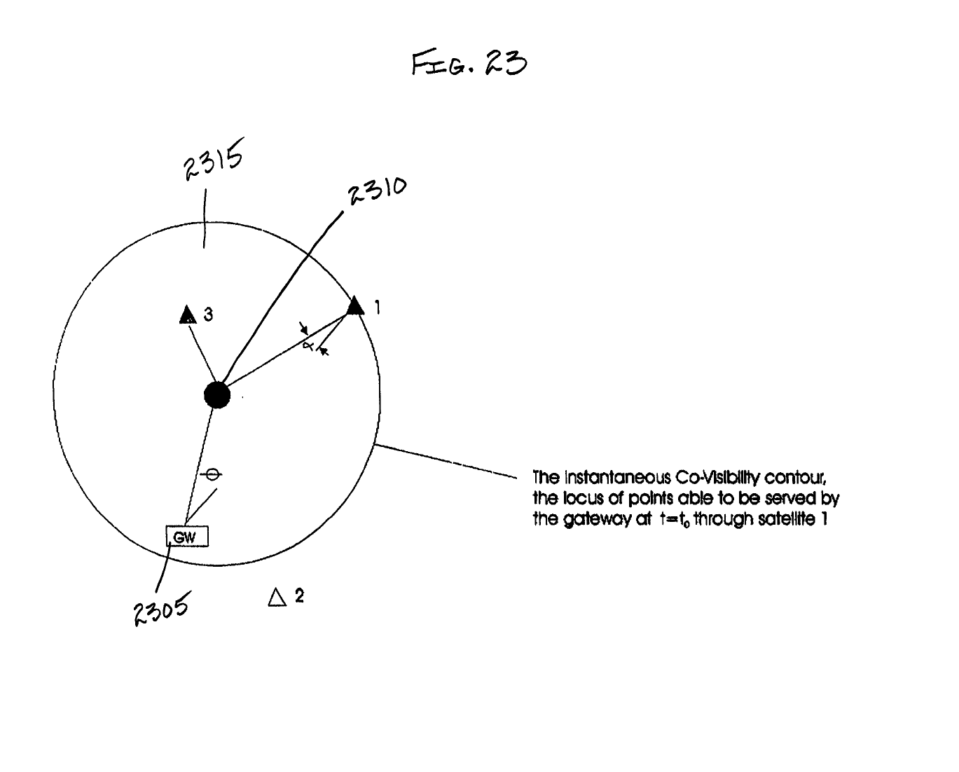

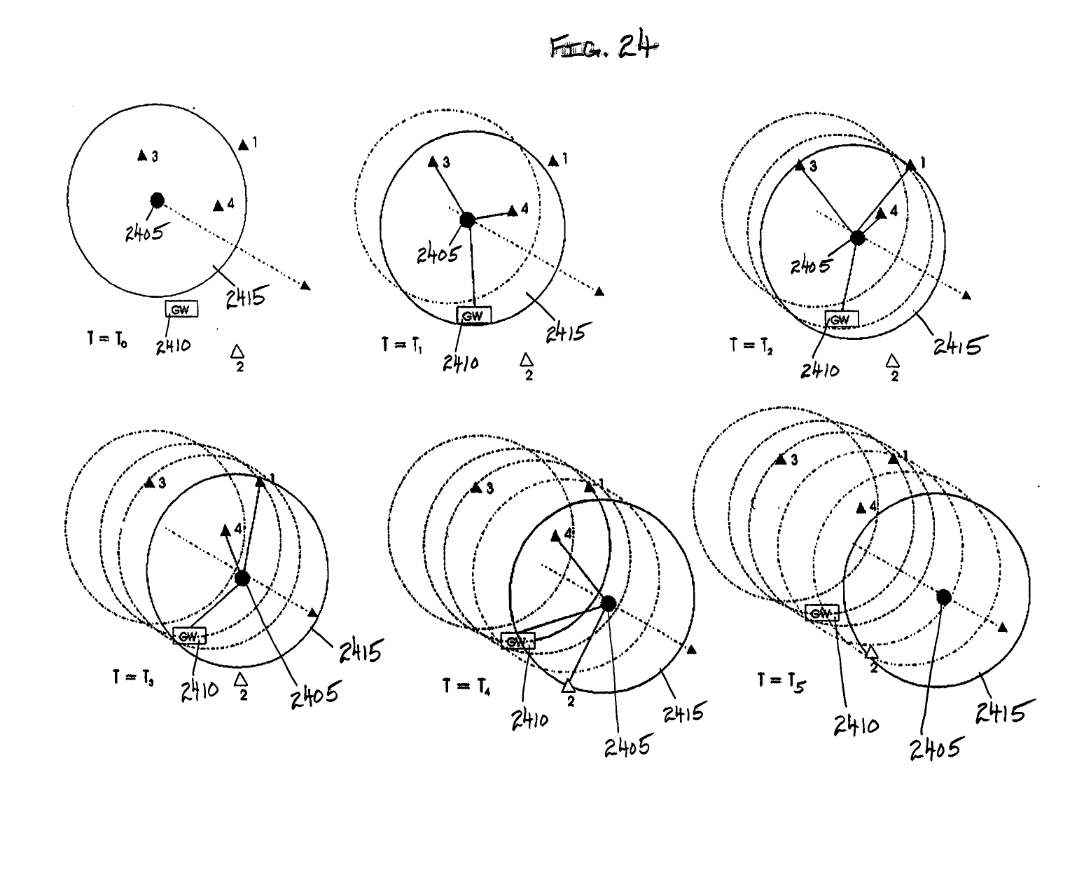

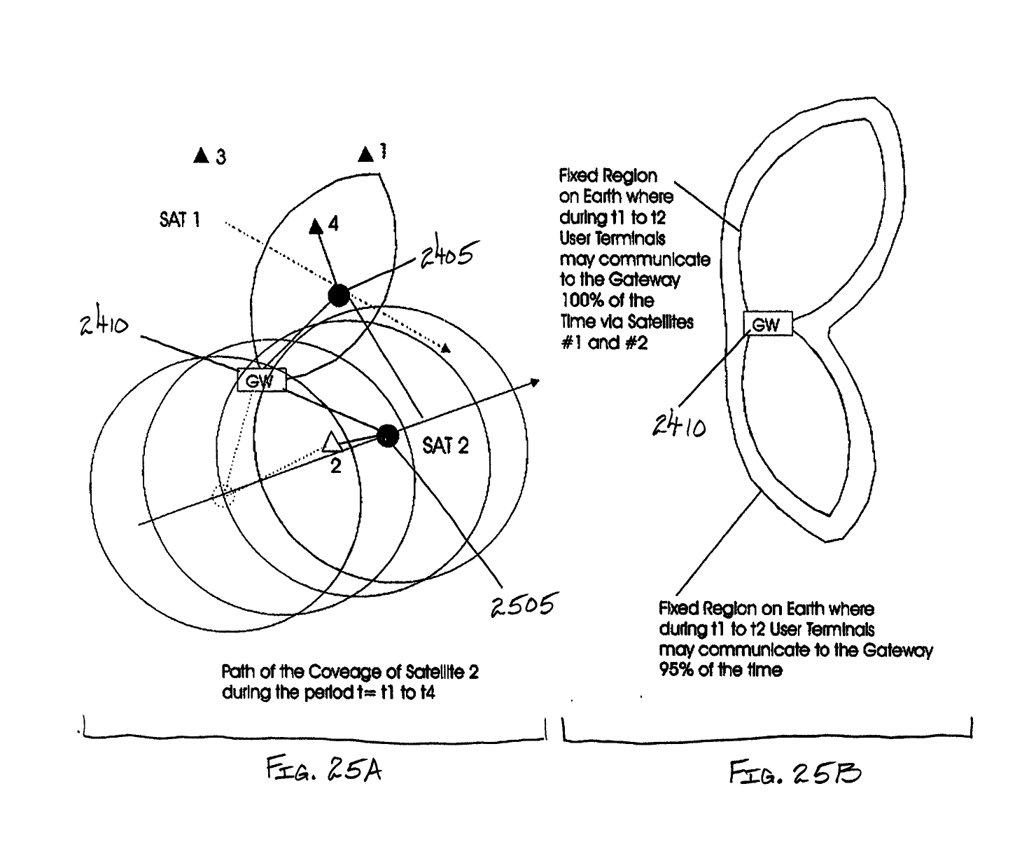

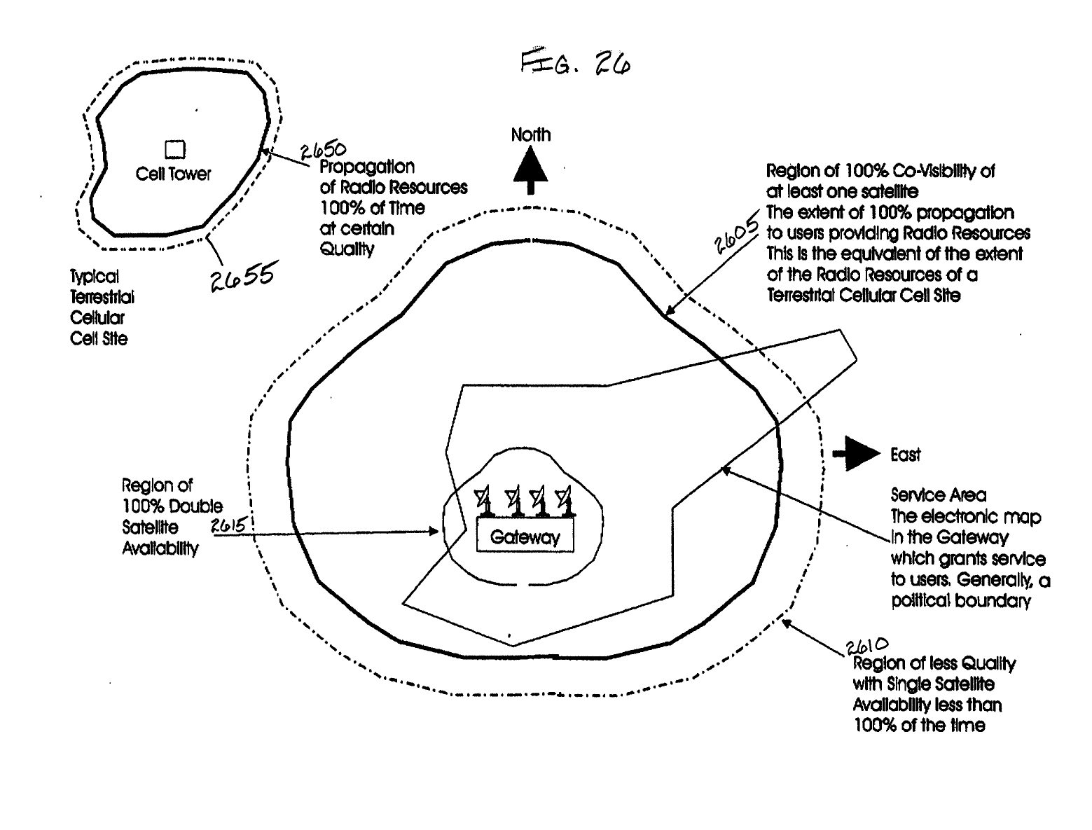

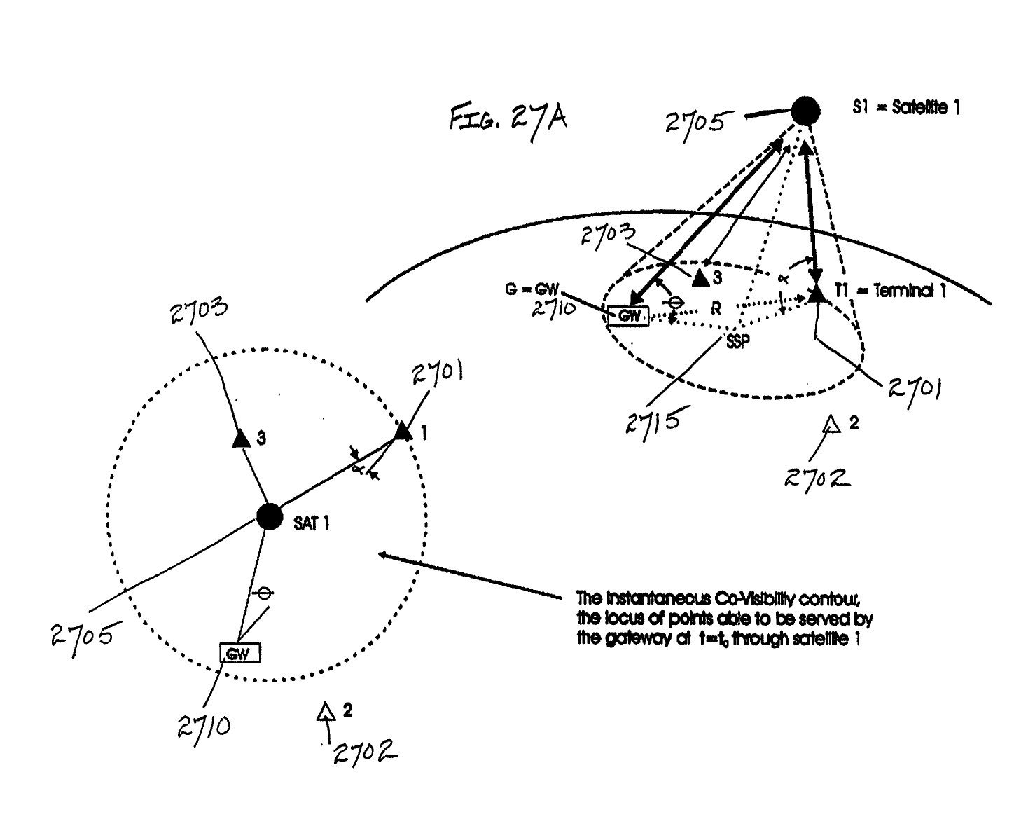

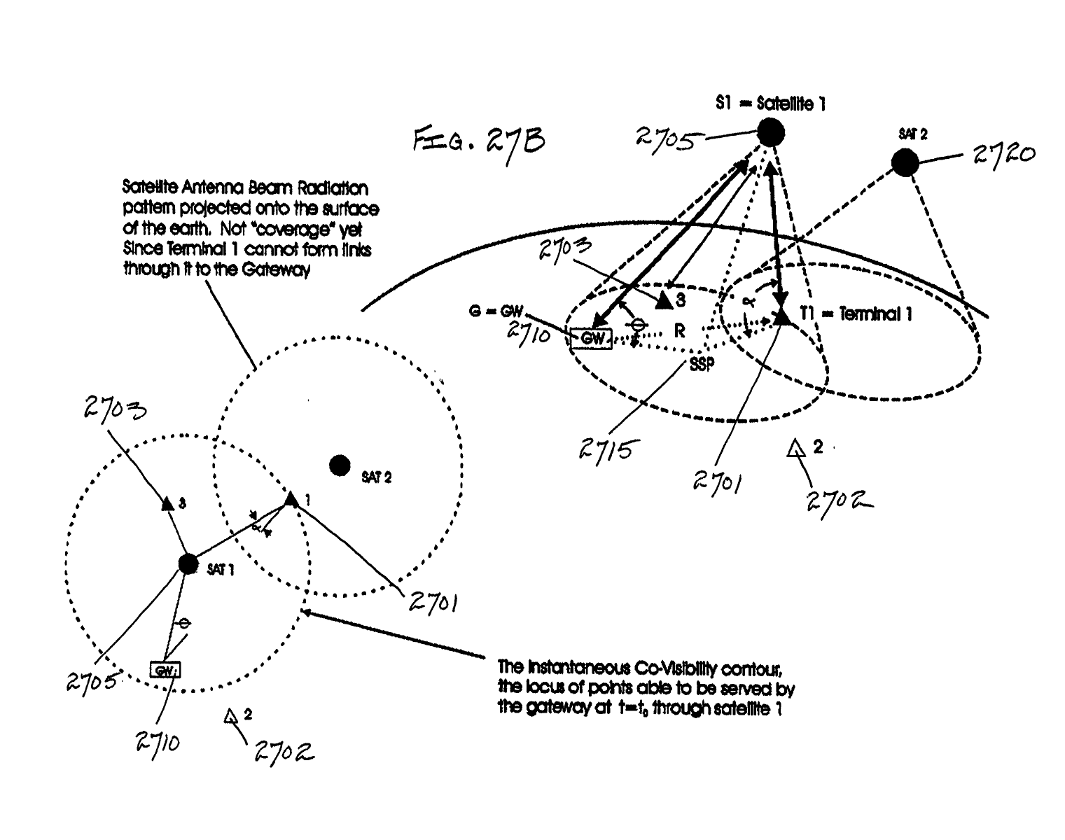

FIG. 22 is a flowchart of a preferred embodiment of a method for resolving an ambiguous position of a UT, in accordance with the present invention. At step 2205, the method is entered from other gateway functions, and progresses to step 2210.

In step 2210, the method determines whether the position of the UT is ambiguous. If the position is ambiguous, then the method progresses to step 2215. If the position is not ambiguous, then the method advances to step 2245.

In step 2215, the method determines whether the last registration of the UT matches the current service provider. If the last registration does not match the current service provider, then the method progresses to step 2220. If the last registration does match the current service provider, then the method advances to step 2250.

In step 2220, the method determines whether the UT reported beam identification is a center beam. If the beam identification is a center beam, then the method advances to step 2230. If the beam identification is not a center beam, then the method progresses to step 2225.

In step 2225, the method attempts to resolve the ambiguity using the return link. If the ambiguity is not resolved using the return link, then the method progresses to step 2230. If the ambiguity is resolved using the return link, then the method advances to step 2045.

In step 2230, the method determines whether both positions of ambiguity are in the service area of the gateway. If both positions of ambiguity are not in the service area, then the method progresses to step 2235. If both positions of ambiguity are in the service area, then the method advances to step 2250.

In step 2235, the method determines whether at least one of the ambiguity positions is in a restricted zone. If at least one of the ambiguity positions is in a restricted zone, then the method progresses to step 2240. If neither of the ambiguity positions are in a restricted zone, then the method advances to step 2250.

In step 2240, the method defers access by the UT until the ambiguity can be resolved. The method then returns to the other gateway functions.

In step 2245, the method determines whether the UT is located in the service area of the gateway. If the UT is located in the service area, then the method progresses to step 2250. If the UT is not located in the service area, then the method progresses to step 2255.

In step 2250, the method registers the UT or allows the UT to make a call on a traffic channel, as requested. The method then returns to other gateway functions.

In step 2255, the method declares that the UT is out of the service area of the gateway. The method then returns to other gateway functions.

The gateway coverage of a multiple satellite system does not equate to the moving fields of view of one, or even more than one, individual satellite. This is true for a low earth orbit satellite system.

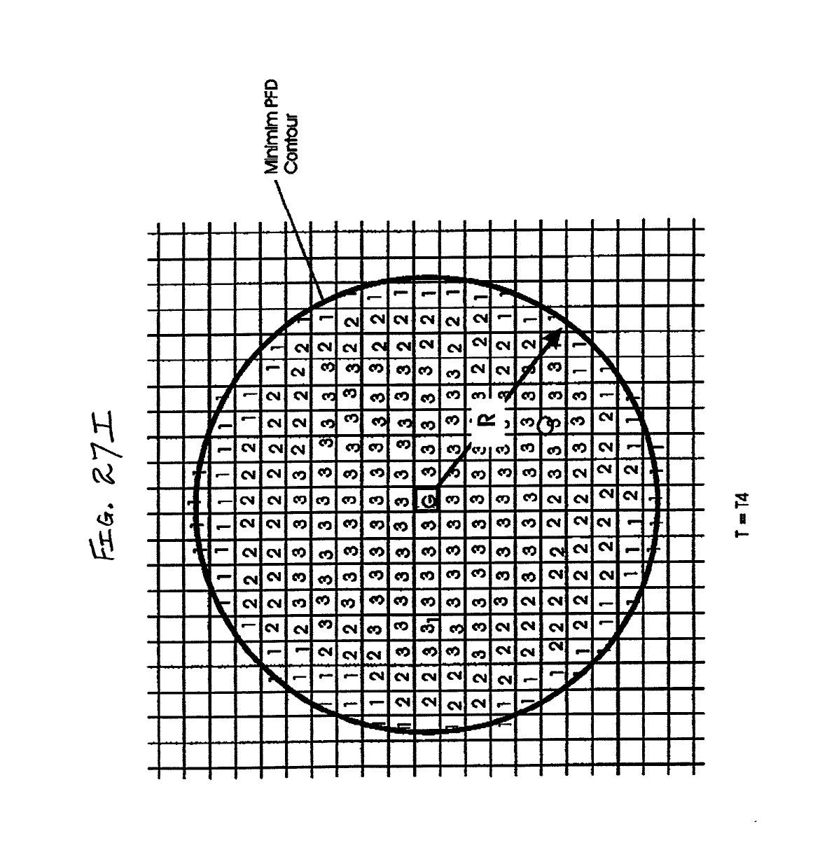

Referring to FIGS. 27A-27I, there is shown a collection of satellite fields of view, which contain multiple beams that are in constant motion over a UT. This collection of satellite Radio Frequency Beams creates, at points on the ground, a composite radio frequency Power Flux Density (PFD). Coverage of the UT depends on the value of the PFD received by the UT. If the UT receives a sufficient PFD it can be connected to an earth station, e.g., a gateway, via a satellite. If insufficient PFD is received, the UT cannot be connected to the gateway via the satellite.

Referring to FIG. 27A, a satellite 2705 is orbiting the earth. It is receiving and transmitting signals from and to a gateway 2710 over a link. A UT 2701 is located on the earth, or above the earth, e.g., on an airplane, and is communicating to gateway 2710 over another link. At an instant in time the geometry of FIG. 27A exists.

For a communications link to be formed there must be co-visibility between gateway 2710 and UT 2701 via satellite 2705. In a practical system, gateway 2710 transmits toward satellite 2705 at a minimum angle of theta (0), which is formed between the link and a line between gateway 2710 and a Sub Satellite Point (SSP) 2715. This construction forms the triangle G-SSP-S1 on the diagram.

Satellite 2705 receives the signal, amplifies it, and retransmits the signal toward the ground. It is received by UT 2701 at some distance from SSP 2715. Depending on system design, the power transmitted by the satellite 2705 is designed to create a PFD at a certain radius from SSP 2715.

There is a minimum angle alpha (a) between the link of UT 2701 to satellite 2705 and the line connecting UT 2701 and SSP 2715. For practical reasons, a minimum useful angle α is about 10 degrees. This construction creates another triangle T1-SSP-S1 on the diagram.

Using spherical and plane trigonometry one can create the triangle G-S1-T1, which has a distance from gateway 2710 to UT 2701 equal to R, the radius or distance from gateway 2710. Moving UT 2701 around the surface of the earth at a constant distance from SSP 2715 creates an instantaneous region of co-visibility that has sufficient PFD to make a communications link to UT 2701.

Note that the region of co-visibility need not be circular, but is defined by the antenna pattern and by the PFD created by it, and that any UT situated at the distance SSP-T1 from SSP will receive an equal PFD, if the design of the satellite antenna and the transmitted power of gateway 2710 is tailored to create an equal PFD. That is to say, any UT located on or within this instantaneous locus of points, called the instantaneous co-visibility contour, is able to register, make calls, and sustain communications. Thus, in the diagram UTs 2701 and 2703 can complete RF links to gateway 2710, while UT 2702, located outside of the locus of points, cannot.

Modifying FIG. 27A by adding a satellite 2720 that has its RF beams covering UT 2701, but not gateway 2710, is shown in FIG. 27B. Satellite 2720 has moved into the area where UT 2701 is active, however, UT 2701 cannot use satellite 2720 even though the RF beam of satellite 2720 is covering UT 2701, because satellite 2720 is not able to cover gateway 2710 with its RF beams. The situation with UT 2701 has not changed and, therefore, there is no reason for UT 2701 to re-register. As such, it can be appreciated that the mere movement of satellite visibility footprints or RF antenna patterns across the surface of the earth does not create a need for mass re-registrations by the UTs.

Moving this configuration in time until both satellites 2705 and 2720 can communicate with gateway 2710 yields FIG. 27C. At this time satellites 2705 and 2720 have moved in space sufficiently that satellite 2720 can receive signals from gateway 2710. UT 2701 is located on the edge of the coverage area of both satellites. Gateway 2710 senses the presence of UT 2701 in the received signal from satellite 2720 and begins to transmit to UT 2701. Link #3 is formed from gateway 2710 to satellite 2720 and, after amplification, satellite 2720 transmits the signal on Link 4 toward the ground. The signal is received by UT 2701 at some distance from SSP 2725. The link triangles GW-SSP2-S2 and T1-SSP2-S2 are formed as discussed above for satellite 2705. Likewise, in a similar manner to that above, using spherical and plane trigonometry the triangle GW-SAT2-T1 is formed and it shares the same R or radius of location from gateway 2710.

Since the radiation patterns of satellites 2705 and 2720 are assumed to be about the same, the PFD at the edge of coverage is the same. UT 2701 is thus communicating via two different satellites, i.e., satellites 2705 and 2720, at the same time. Notice that the movement of the satellite visibility footprints or RF antenna patterns across the surface of the earth did not create a need to re-register UT 2701.

For a period of time both satellites continue to communicate with UT 2701 located at R distance from gateway 2710. Now, and referring to FIG. 27D, satellite 2705 has moved such that it can no longer communicate with UT 2701, therefore Links #1 and #2 are no longer formed. However, satellite 2720 is still in communication with UT 2701, located at a radius R from gateway 2710, over Links 3 and 4 and is operating at the same received PFD as before. Notice that there was no need to re-register UT 2701, and furthermore no mass re-registrations occurred because of the movement of the satellites 2705 and 2720.

The preceding discussion shows that as long as a UT remains at a certain radius R from a gateway, and the PFD is such that the UT is able to maintain communication with the gateway, the user may continue to make calls independent of the movement of the satellite antenna patterns projected onto the surface of the earth.

A definition is now provided of a zone around a gateway wherein a UT may continuously achieve connection continuity with the gateway. Computer simulations, or actual Radio Frequency signal strength measurements, may be used to define the zone. The process is straightforward. The gateway is placed at a particular latitude and longitude. The area surrounding the gateway is divided into a checkerboard of small squares. A desired minimum PFD is selected. A link budget program with the satellite ephemeri included is run for each satellite antenna pattern of the constellation projected onto the earth. The program records the maximum PFD at that instant in time in each square caused by the satellites that are overhead at that instant. The constellation is then advanced in time, for example by one minute, and the link budget calculation is repeated, and the maximum PFD recorded. This process is continued until the constellation ground track repeats itself. The maximum PFD in each square is thus recorded.

A graphical representation of this process is shown in FIGS. 27E-27H. For illustrative purposes the satellites are shown advancing in such a manner that the gateway accesses them sequentially and, in fact, the gateway is in constant contact with two or more satellites. Note should be made that using the presently preferred constellation, at the equator a small percentage of the time, there is only one satellite with its RF footprint such that the gateway can contact it. At a short time later a second satellite begins to contact the gateway while the gateway is still in contact with the first satellite.

In FIG. 27E, a “black” satellite is shown in contact with a gateway. The instantaneous PFD in each square generated by the black satellite antenna pattern is shown as the numbers 1, 2, and 3 for illustrative purposes. These values are usually provided in terms of PFD per square meter per MHz, with values of approximately −126 dbW/m²/MHz to −113 dbW/m²/MHz. As shown, a “white” satellite has not yet begun contact with the gateway.

In FIG. 27F, the black satellite no longer contacts the gateway, and the white satellite has begun communications with the gateway. At this time, for example 1 minute later than FIG. 27E, the values of the white satellite are recorded. If a particular square has a higher PFD it is recorded. In the diagram the dark outline squares have changed PFD. Notice a ring of squares with the value 1 is beginning to form about the gateway.

In FIG. 27G, a second black satellite is approaching the operation point with the gateway, but is not in contact yet, and the white satellite has moved on in its orbit. The PFD values are recorded 1 minute after the previous snapshot in FIG. 27F. Again, notice the changed PFD squares with a dark outline.

In FIG. 27H the white satellite has lost contact with the gateway and the second black satellite is beginning its pass. The minimum PFD contour is taking a characteristic circular shape as shown in FIG. 27I.

By continuing this process eventually a shape emerges, dependent on the constellation parameters and the latitude of the gateway, that has a minimum PFD that exists 100% of the time. Notice that a UT is not required to develop the minimum PFD contour. As long as the UT remains within this contour, access from the gateway, or access messages to the gateway, may be sent and received without re-registering the UT with the gateway.

In order to use these PFD contours, the calculated PFD contours are established as a series of points or nodes in a database in the gateway memory. The data is input to a computer program for use in accepting or rejecting UTs from registering or operating in certain modes. The electronic map of the service area thus created is composed of the nodes, and connecting lines, which may be preferably straight or curved according to a mathematical formula. Combinations of the contours may be at various PFD levels. The PFD levels thus created are not necessarily static. They may be either temporary or fixed, or may be varying with time. Since the gateway can be moving, the PFD level contours may be moving also. It is possible that the PFD contours can be changing in both magnitude and position at the same time.

While the invention has been particularly shown and described with respect to preferred embodiments thereof, it will be understood by those skilled in the art that changes in form and details may be made therein without departing from the invention. Accordingly, the present invention is intended to embrace all such alternatives, modifications and variances that fall within the scope of the appended claims.

What is claimed is:

1. A method for determining whether a gateway will service a user terminal in a satellite communication system, comprising steps of:
determining whether a position of said user terminal is ambiguous; and
if said position is ambiguous:
determining whether a previous registration of a service provider for said user terminal matches a current service provider accessible via said gateway; and
if said previous registration matches said current service provider, then accepting said user terminal for service by said gateway.

2. A method for determining whether a gateway will service a user terminal in a satellite communication system, comprising steps of:
determining that said user terminal is at either of two ambiguous positions;
determining whether both of said two ambiguous positions are within a service area of said gateway; and
if both of said two ambiguous positions are within said service area, then accepting said user terminal for service by said gateway.

3. A method for determining whether a gateway will service a user terminal in a satellite communication system, comprising steps of:
determining that said user terminal is at either of two ambiguous positions;
determining whether at least one of said two ambiguous positions is within a restricted area for which said gateway does not provide service; and
if at least one of said two ambiguous positions is within said restricted area, then rejecting said user terminal for service by said gateway.

4. A method for resolving a position of a user terminal in a satellite communication system, comprising steps of:
determining that said user terminal is at either of two ambiguous positions;
determining a parameter of a beam transmitted from said user terminal to a satellite of said satellite communication system; and
determining that said user terminal is at a first of said two ambiguous positions based on said parameter.

5. The method of claim 4, wherein said parameter is an antenna pattern of said beam.

6. The method of claim 4, wherein said parameter is signal strength of said beam.

7. A method for determining whether a first gateway will service a user terminal in a satellite communication system, comprising steps of:
determining, based on data from a first satellite of said communication system that has a radio frequency (RF) link to said first gateway, that a position of said user terminal is ambiguous;
determining, at a second gateway, based on data from a second satellite of said satellite communication system that does not have an RF link to said first gateway, an unambiguous position of said user terminal;
obtaining said unambiguous position from said second gateway; and
if said unambiguous position indicates that said user terminal is located in a service area of said first gateway, then accepting said user terminal for service by said first gateway.

8. A method for determining whether a gateway will service a user terminal in a satellite communication system, comprising steps of:
determining, based on data from a first satellite of said communication system that has a radio frequency (RF) link to said gateway, that a position of said user terminal is ambiguous;
obtaining, from a second satellite of said communication system that does not have an RF link to said gateway, data relating to said position of said user terminal;
determining, from said data from said second satellite, an unambiguous position of said user terminal; and
if said unambiguous position indicates that said user terminal is located in a service area of said gateway, then accepting said user terminal for service by said gateway.
